(19) United States
(12) Patent Application Publication
(10) Pub. No.: US 2025/0349944 A1
(43) Pub. Date: Nov. 13, 2025

(54) SYSTEMS AND METHODS FOR CONTROLLING DENDRITE PROPAGATION IN SOLID-STATE ELECTROCHEMICAL CELLS

(71) Applicant: Massachusetts Institute of Technology, Cambridge, MA (US)

(72) Inventors: Yet-Ming Chiang, Weston, MA (US); W. Craig Carter, Boston, MA (US); Coleman Fincher, Dallas, TX (US); Brian Sheldon, Brookline, MA (US)

(73) Assignee: Massachusetts Institute of Technology, Cambridge, MA (US)

(21) Appl. No.: 18/871,319

(22) PCT Filed: Jun. 5, 2023
(86) PCT No.: PCT/US2023/067940

§ 371 Date: Dec. 3, 2024

Related U.S. Application Data
(60) Provisional application No. 63/348,977, filed on Jun. 3, 2022.
(60) Provisional application No. 63/358,772, filed on Jul. 6, 2022.

(51) Int. Cl. H01M 50/10; H01M 4/02; H01M 4/38; H01M 4/525; H01M 4/58; H01M 10/0525; H01M 10/0562

(52) U.S. Cl. CPC H01M 50/10; H01M 4/382; H01M 4/525; H01M 4/5825; H01M 10/0525; H01M 10/0562; H01M 2004/027; H01M 2004/028; H01M 2300/0077

(57) ABSTRACT

A solid-state electrochemical cell includes a solid electrolyte where at least a portion of the electrolyte is in a compressive stress state. The compressive stress state includes at least one stress component that is orthogonal to the preferred direction of dendrite growth, which may correspond to the direction of an electric field. If the magnitude of the stress component is sufficiently large (e.g., greater than 50 MPa), then the growth of a dendrite passing through that portion of the electrolyte may be suppressed or deflected towards the direction of the applied stress component. In this manner, a dendrite may be deflected away from a cathode, thus prolonging the life of the cell. The compressive stress state may be generated by applying an external mechanical load to the cell and/or generating a residual stress in the cell during manufacture or assembly.

### CROSS-REFERENCE TO RELATED APPLICATION(S)

This application claims the priority benefit, under 35 U.S.C. 119(e), of U.S. Application No. 63β48,977, filed Jun. 3, 2022 and entitled, “SOLID STATE BATTERY DESIGN AND METHOD OF FABRICATION,” and U.S. Application No. 63β58,772, filed Jul. 6, 2022 and entitled, “SOLID STATE BATTERY DESIGN AND METHOD OF FABRICATION.” Each of the aforementioned references is incorporated herein by reference in its entirety.

### BACKGROUND

A solid-state battery is distinguished from other types of batteries by the use of a solid electrolyte instead of a liquid or gel electrolyte. For a lithium (Li) ion battery, a solid electrolyte offers several advantages over conventional liquid or gel electrolytes. For example, solid electrolytes that are compatible with a Li-based electrochemistry typically have a higher density and are non-flammable. Thus, the energy density of a Li ion solid-state battery has the potential to be appreciably higher than conventional Li ion batteries with liquid or gel electrolytes. Additionally, a Li ion solid-state battery is potentially safer than conventional Li ion batteries, at least when exposed to an external heat source (e.g., a fire).

### SUMMARY

The Inventors have recognized and appreciated a solid-state battery—in particular, a Li ion solid-state battery—has the potential to address several limitations of conventional Li ion batteries with liquid or gel electrolytes, such as limited energy density, high volatility (e.g., flammability), and poor cycle life. However, the Inventors have also recognized that at practical current densities, metal filaments (also referred to as “dendrites”) can readily pierce the solid electrolyte, thus causing a short-circuit, which comprises the batteries' operation and safety. For example, in Li ion solid-state batteries, Li dendrites often form at the interface between a Li anode and the solid electrolyte. The Li dendrites typically grow over time as the battery is cycled, eventually penetrating through the electrolyte and contacting the cathode, resulting in a short circuit.

The present disclosure is thus directed to various inventive implementations of a solid-state electrochemical cell (also referred to herein as a “cell”) that includes a solid electrolyte in a compressive stress state to suppress and/or deflect the growth of metal dendrites. Metal dendrites typically grow along the direction of an electric field between the anode and the cathode. To suppress and/or deflect the metal dendrites, the compressive stress state may include at least one stress component that is substantially orthogonal to the direction of an electric field between the anode and the cathode.

When metal dendrites originating from a first electrode (e.g., a Li anode) enter the solid electrolyte, the compressive stresses in the solid electrolyte may either suppress the growth of the dendrites or deflect the dendrites away from a second electrode (e.g., a cathode). In this manner, the life of a solid-state battery may be extended by forcing the dendrite to follow a longer and, in some instances, more tortuous path before reaching the second electrode and causing a short circuit. In some implementations, the compressive stress may be sufficient to deflect the dendrites along a direction parallel to the interface of the solid electrolyte and the cathode, thus preventing the dendrites from reaching the second electrode and mitigating the risk of a short circuit.

The suppression and/or deflection of dendrites may also be improved by reducing or, in some instances, eliminating any stress components in the compressive stress state that are aligned parallel to the direction of the electric field. For example, a stack pressure is often applied to conventional electrochemical cells to increase critical current densities and improve the uniformity of metal deposition. However, the stack pressure also promotes dendrite growth towards the cathode. Thus, in some implementations, the cells disclosed herein subjected to a small stack pressure (e.g., less than 50 MPa) or, in some instances, no stack pressure.

The desired compressive stress state in the solid electrolyte may be introduced in several ways. In some implementations, an external mechanical load may be applied to at least the solid electrolyte of the cell. This may be accomplished using, for example, a casing to enclose the cell. In one example, the casing may include a clamp to securely couple the cell to the casing by applying a compressive load onto the cell. In another example, the cell may be bonded to a surface of the casing in a manner that produces a compressive stress applied to the cell. For instance, the cell may be bonded to the casing at an elevated temperature and when cooled, a thermal expansion mismatch between the casing and the cell may induce a compressive stress within the cell.

In some implementations, a residual stress may be generated within the cell and, in particular, the solid electrolyte. For example, a cathode may be formed onto the solid electrolyte or, alternatively, the solid electrolyte may be formed on a cathode at an elevated temperature. When the assembly of the cathode and the solid electrolyte is cooled, a thermal expansion mismatch between the solid electrolyte and the cathode may induce a compressive stress in the solid electrolyte. In another example, a composite solid electrolyte including, for example, at least two layers of different solid electrolyte materials having different thermal expansion coefficients may similarly be formed at an elevated temperature and subsequently cooled to induce a compressive stress in at least one layer of solid electrolyte. In yet another example, the solid electrolyte in the cell may be locally reduced via an electrochemical or chemical reaction to produce an electrolyte phase with a different volume (e.g., an expanded volume). The change in volume of the solid electrolyte relative to the anode and/or the cathode may produce a compressive stress in the solid electrolyte.

It should be appreciated that the solid-state electrochemical cells described herein may be readily integrated into a solid-state battery. Said another way, a solid-state battery may generally include one or more of the solid-state electrochemical cells disclosed herein. For example, a solid-state battery may include multiple electrochemical cells stacked onto one another and a pair of current collectors disposed at opposing ends of the cell stack to electrically couple the cell stack to a load.

In one example implementation, a solid-state electrochemical cell comprises: an anode comprising lithium (Li); a cathode; and a solid electrolyte disposed between and directly coupled to the anode and the cathode where at least a portion of the solid electrolyte is under compressive stress. Additionally, while charging or discharging the cell, an electric field is generated in the solid electrolyte between the anode and the cathode. The compressive stress includes at least one stress component oriented along a first direction that is substantially orthogonal to a direction of the electric field in the portion of the solid electrolyte. The at least one stress component is configured to deflect a Li dendrite, originating from the anode and located in the portion of the solid electrolyte, away from the cathode.

For this example implementation, an angle between the first direction of the at least one stress component and the direction of the electric field may range from about 85 degrees to about 95 degrees. The at least one stress component may have a magnitude ranging from about 50 MPa to about 1000 MPa. The at least one stress component may be configured to deflect the Li dendrite by causing a change in a propagation angle of the Li dendrite where the change in the propagation angle ranges from about 10 degrees to about 90 degrees. The at least one stress component may be configured to deflect the Li dendrite towards the first direction such that an angle between the first direction and a propagation direction of the Li dendrite is less than or equal to about 10 degrees. The solid electrolyte has a width parallel to the first direction and the portion of the solid electrolyte under compressive stress may extend across the width of the solid electrolyte. The compressive stress may be a uniaxial compressive stress oriented along the first direction. The compressive stress may be a biaxial compressive stress oriented along the first direction and a second direction orthogonal to the first direction and the direction of the electric field in the portion of the solid electrolyte.

The cell may further include a casing to enclose the anode, the cathode, and the solid electrolyte where the casing applies a mechanical load to at least one of the anode, the cathode, or the solid electrolyte thereby causing the portion of the solid electrolyte to be under compressive stress. The casing may comprise a clamp to securely couple the anode, the cathode, and the solid electrolyte to the casing such that the clamp applies the mechanical load to the at least one of the anode, the cathode, or the solid electrolyte. The casing includes a surface and one of the anode or the cathode may be bonded to the surface such that a residual stress is generated at the one of the anode or the cathode where the residual stress causes the mechanical load to be applied to the at least one of the anode, the cathode, or the solid electrolyte. The mechanical load may bend the anode, the cathode, and the solid electrolyte thereby generating a bending stress in the anode, the cathode, and the solid electrolyte with the bending stress causing at least the portion of the solid electrolyte to be under compressive stress. The casing may not apply a stack pressure to the anode, the cathode, and the solid electrolyte.

The compressive stress may be caused by a thermal expansion mismatch between the cathode and the solid electrolyte. The solid electrolyte may have a first thickness less than a second thickness of the cathode and the solid electrolyte may have a first coefficient of thermal expansion less than a second coefficient of thermal expansion of the cathode. The solid electrolyte may comprise at least one of an oxide electrolyte, a crystalline sulfide electrolyte, or a lithium super ionic conductor (LISICON) electrolyte and the cathode may comprise at least one of a nickel manganese cobalt oxide, or a lithium iron phosphate. The solid electrolyte may comprise: a first layer of a first solid electrolyte, the first layer including the portion of the solid electrolyte under compressive stress; and a second layer, coupled to the first layer, of a second solid electrolyte different from the first solid electrolyte where the compressive stress is caused by a thermal expansion mismatch between the first layer and the second layer. The compressive stress may be caused by at least one of an electrochemical reaction or a chemical reaction at the portion of the solid electrolyte.

In another example implementation, a solid-state electrochemical cell comprises: an anode comprising lithium (Li); a cathode; a solid electrolyte disposed between and directly coupled to the anode and the cathode, at least a portion of the solid electrolyte is under compressive stress, the compressive stress being caused by a thermal expansion mismatch between the cathode and the solid electrolyte; and a casing to enclose the anode, the cathode, and the solid electrolyte.

Additionally, while charging or discharging the cell, an electric field is generated in the solid electrolyte between the anode and the cathode. The compressive stress includes at least one stress component oriented along a first direction that is substantially orthogonal to a direction of the electric field in the portion of the solid electrolyte. The casing does not apply a stack pressure to the anode, the cathode, and the solid electrolyte.

In another example implementation, a method of making a solid-state electrochemical cell comprises: joining together an anode, a solid electrolyte, and a cathode at a first temperature such that the solid electrolyte is disposed between and directly coupled to the anode and the cathode; cooling the anode, the solid electrolyte, and the cathode from the first temperature to a second temperature less than the first temperature at a cooling rate sufficient to generate a residual thermal stress in at least the solid electrolyte where the residual thermal stress causes at least a portion of the solid electrolyte to be under compressive stress so as to deflect a Li dendrite in the portion of the solid electrolyte during operation of the cell; joining the anode to a first electrode; joining the cathode to a second electrode; and mounting the anode, the solid electrolyte, and the cathode to a casing such that the casing does not cause a stack pressure to at least the solid electrolyte with a magnitude greater than 10 MPa. Additionally, during operation of the cell, an electric field is generated in the solid electrolyte between the anode and the cathode and the compressive stress includes at least one stress component oriented along a first direction that is substantially orthogonal to a direction of the electric field in the portion of the solid electrolyte.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows an example solid-state electrochemical cell with a sandwich-style geometry.

FIG. 1B shows a magnified view of the dendrite in the cell of FIG. 1A.

FIG. 2 shows another example solid-state electrochemical cell with a curved geometry.

FIG. 3A shows an example casing with a clamp to apply a mechanical load to a solid-state cell.

FIG. 3B shows an example casing with a solid-state cell bonded to a surface of the casing such that a mechanical load is applied to the cell.

FIG. 4A shows another example solid-state electrochemical cell with a multi-layered solid electrolyte, a composite cathode, and a Li anode.

FIG. 4B shows another example solid-state electrochemical cell with a co-sintered composite electrolyte and cathode coupled to a Li anode.

FIG. 5 shows another example solid-state electrochemical cell where a portion of the solid electrolyte is locally reduced to form a different electrolyte phase.

FIG. 6A shows an example testing apparatus to investigate the effect of an applied stress on the propagation of a Li dendrite in a sample solid-state cell.

FIG. 6B shows the geometry of the plan-view sample cell of FIG. 6A and the orientation of dendrites grown in a load-free configuration. The inset shows an applied current generates a plating-induced pressure (P) inside metal-filled flaws at the anode and electrolyte interface. This pressure acts normally to the flaw surface, wedging open the flaw and allowing metal dendrites to propagate through the cell.

FIG. 6C shows the plan-view cell of FIG. 6B under a mechanical load, which results in a compressive stress applied to the electrolyte. The inset shows a compressive stress (σ_{applied}) applied along the axis of the cantilever beam opposes the plating-induced pressure P.

FIG. 6D shows the plan-view cell of FIG. 6C and dendrite deflection when propagating under the mechanical load.

FIG. 7 shows an image of an example dendrite propagating through the electrolyte of a sample cell with and without an applied mechanical load. The image was recorded using an optical microscope viewing the sample cell through a portion of the cantilever beam.

FIG. 8 shows electrochemical data corresponding to the experiment performed in FIG. 7.

FIG. 9A shows another image of the sample cell of FIG. 7 acquired while no mechanical was applied to the cell.

FIG. 9B shows another image of the sample cell of FIG. 7 acquired while the mechanical load was applied to the cell.

FIG. 10 shows several images of the effect of an applied mechanical load on the propagation of multiple metal dendrites for a sample cell with a 30 μm thick electrolyte. The images were acquired using operando microscopy. For frames a-e, a galvanostatic current density of 0.3 mA/cm² was applied to the sample cell. For frames f-j, the galvanostatic current density was progressively increased from 1.4 mA/cm² to 5.6 mA/cm².

FIG. 11A shows several images of the effect of an applied mechanical load on the propagation of multiple metal dendrites for a sample cell with a 250 μm thick electrolyte. The segments of the dendrites grown under different current/load conditions are shown in respective frames. The frames a-e were recorded using strong backlighting (i.e., light positioned below the transparent cantilever).

FIG. 11B shows a micrograph recorded after the experiment of FIG. 11a was finished. The image was recorded while the illuminating light source was positioned above the cantilever beam. The dotted line outlines metal growth plated without an applied compressive stress. The dashed line outlines the metal growth with an applied compressive stress.

FIG. 12A shows a diagram of the loading conditions used to model kinked propagation of metal dendrites.

FIG. 12B shows a chart of the most energetically favorable propagation angle as a function of initial crack-inclination angle β for different values of \hat{σ}=σ_{yy}/P. The curve for \hat{σ}=0 represents the case where the only stress in the system is P such that θ=β. Increasingly positive \hat{σ} values represent increasing compressive loadings, which then increase the value of θ relative to that for \hat{σ}=0, causing deflection. In the limit where θ=90°, the metal dendrite cannot reach the counter electrode regardless of the lateral dimensions of the electrolyte.

FIG. 12C shows the value of \hat{σ} to produce θ=90°, θ=60°, and θ=30° as a function of crack inclination β.

FIG. 12D shows the most energetically favorable propagation angle θ as a function of inclination angle β for different values of \hat{σ}=σₓₓ/P. Increasingly positive \hat{σ} represent increasing compressive stack pressures, where stack pressures approaching the magnitude of P tend to decrease the propagation angle relative to \hat{σ}=0.

FIG. 13A shows a table of the biaxial modulus and the coefficient of thermal expansion for various cathodes and electrolytes.

FIG. 13B shows the residual compressive stress at the solid electrolyte/cathode interface for various cathodes and electrolytes. Individual series represent separate sets of electrolyte/cathode or electrolyte/electrolyte assemblies. For any given label, the first of two constituents listed (i.e., A in A/B) represents the anode-facing material. The compressive stress plotted represents the biaxial stress in the electrolyte plane, acting normally to the stack direction.

FIG. 14A shows electrochemical data corresponding to the experiment performed in frames a-e of FIG. 10.

FIG. 14B shows additional images of the sample cell under the different current density and loading conditions of FIG. 14A.

FIG. 15A shows electrochemical data corresponding to the experiment performed in frames f-j of FIG. 10.

FIG. 15B shows additional images of the sample cell under the different current density and loading conditions of FIG. 15A.

FIG. 16A shows electrochemical data corresponding to the experiment performed in FIG. 11A.

FIG. 16B shows additional images of the sample cell under the different current density and loading conditions of FIG. 16A.

### DETAILED DESCRIPTION

Following below are more detailed descriptions of various concepts related to, and implementations of, a solid-state electrochemical cell that includes a solid electrolyte subjected to a compressive stress to suppress and/or deflect dendrite growth and methods for making a solid-state electrochemical cell. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of solid-state electrochemical cells are provided, wherein a given example or set of examples showcases one or more features of a solid electrolyte, a cathode, an anode, and a casing for the cell. It should be appreciated that one or more features discussed in connection with a given example of a solid-state electrochemical cell may be employed in other examples of solid-state electrochemical cells according to the present disclosure, such that the various features disclosed herein may be readily combined in a given solid-state electrochemical cell according to the present disclosure (provided that respective features are not mutually inconsistent).

Certain dimensions and features of the solid-state electrochemical cell are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

1. Example Solid-State Electrochemical Cells with a Compressive Stress State

The growth and propagation of metal dendrites in solid electrolytes is primarily driven by mechanical fracture. As the dendrite grows in a flaw in the solid electrolyte (e.g., via metal plating during cycling of an electrochemical cell), the dendrite exerts a pressure against the surfaces of the flaw. When the pressure is sufficient to fracture the solid electrolyte, the flaw propagates forward allowing the dendrite to grow further (see Section 2.2 for further details). Herein, the solid electrolyte of a solid-state electrochemical cell is subjected to a compressive stress that counteracts, at least in part, the internal stress generated by dendrites in the solid electrolyte. The compressive stress may thus be used to suppress further dendrite growth and/or deflect the dendrite along a desired direction (e.g., away from a cathode) to reduce or, in some instances, mitigate the creation of a short circuit.

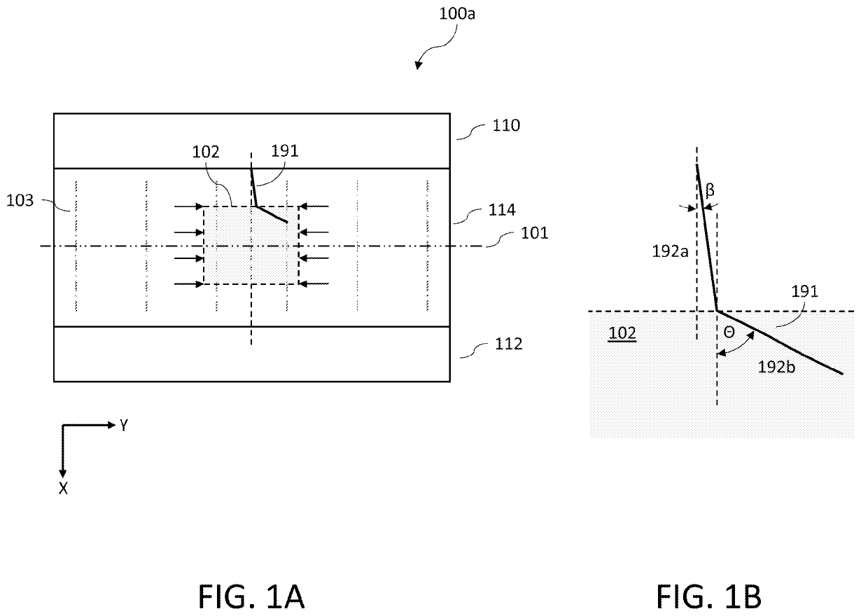

As an illustrative example, FIG. 1A shows a solid-state cell 100a with a sandwich-style geometry. As shown, the cell 100a includes an anode 110, a cathode 112, and a solid electrolyte 114 disposed between and coupled to the anode 110 and the cathode 112. During operation of the cell 100a, an electric field 103 is produced between the anode 110 and the cathode 112. For the sandwich-style geometry, the electric field 103 may be aligned along the X axis. The solid electrolyte 114 also includes a portion 102 in a compressive stress state. As shown, the compressive stress state only includes a compressive stress component applied along the Yaxis. It should be appreciated that, in some implementations, the compressive stress component may be applied only along a Z axis orthogonal to the X and Y axes or applied along a plane 101 defined by the Y and Z axes.

As the cell 100a is cycled, a dendrite 191 may form at the interface between the anode 110 and the solid electrolyte 114 and initially propagate towards the cathode 112 based on the orientation of the electric field 103. FIG. 1B shows a magnified view of the dendrite 191. As shown, the dendrite 191 may initially grow at an angle β relative to the X axis (see segment 192a). The initial orientation of the dendrite 191 may vary based, in part, on variations in morphological defects at the interface between the anode 110 and the solid electrolyte 114. However, the dendrite 191 may nevertheless propagate towards the cathode 112 based on the direction of the electric field 103 in the absence of any other stresses in the solid electrolyte 114.

When the dendrite 191 encounters the portion 102, the compressive stresses applied to the portion 102 may balance the internal stresses generated by the dendrite 191 along at least the Y axis. In some implementations, the compressive stress may slow further propagation of the dendrite 191 or, in some instances, stop propagation entirely. In some implementations, the compressive stress may alter the direction that the dendrite 191 propagates. For example, FIG. 1B shows the dendrite 191 is deflected at an angle Θ relative to the X axis (see segment 192b). The dendrite 191 may continue to propagate at the angle Θ until the dendrite 191 passes through the portion 102. Thereafter, the dendrite 191 may propagate at a smaller angle (e.g., the angle β) if the remainder of the solid electrolyte 114 is not in a compressive stress state. In this manner, the compressive stresses applied to the portion 102 may be leveraged to either suppress or alter the propagation direction of the dendrite 191.

It should be appreciated that the cell 100a is a non-limiting example. More generally, the solid electrolyte 114 may include multiple portions 102 having the same or similar compressive stress state. In some implementations, the entire solid electrolyte 114 may be in a compressive stress state. Thus, the propagation of any dendrites 191 entering the solid electrolyte 114 may be affected by the compressive stresses induced or applied to the solid electrolyte 114.

The compressive stress state in the portion 102 of the solid electrolyte 114 may generally include at least one compressive stress component oriented substantially orthogonal to a preferred direction of dendrite growth in the absence of the compressive stress state. Said another way, the compressive stress state may not include only stress components oriented parallel to the preferred direction of dendrite growth. For example, the preferred direction of dendrite growth may correspond to the direction of the electric field (e.g., the electric field 103) within that portion of the solid electrolyte 114. Thus, in some implementations, the compressive stress state may include at least one compressive stress component located in a plane normal to the electric field vector for the electric field for that portion of the solid electrolyte 114 (e.g., plane 101 normal to the X axis in the cell 100a of FIG. 1A).

In some implementations, the angle between the at least one stress component and the preferred direction of dendrite growth (e.g., the direction of an electric field) may range from about 85 degrees to about 95 degrees. More preferably, this angle may range from about 89 degrees to about 91 degrees. The term “about,” when used to describe the angle between the compressive stress component used to suppress and/or deflect dendrites and the preferred direction for dendrite growth, is intended to cover the precision that this angle may be measured or calculated (see Sections 2.1. and 2.2). For example, “about 90 degrees” may correspond to the following ranges: 89.1 to 90.9 degrees (+/−1% variability), 88.2 to 91.8 degrees (+/−2% variability), 87.3 to 92.7 degrees (+/−3% variability), 86.4 to 93.6 degrees (+/−4% variability), 85.5 to 94.5 degrees (+/−5% variability), including all values and sub-ranges in between.

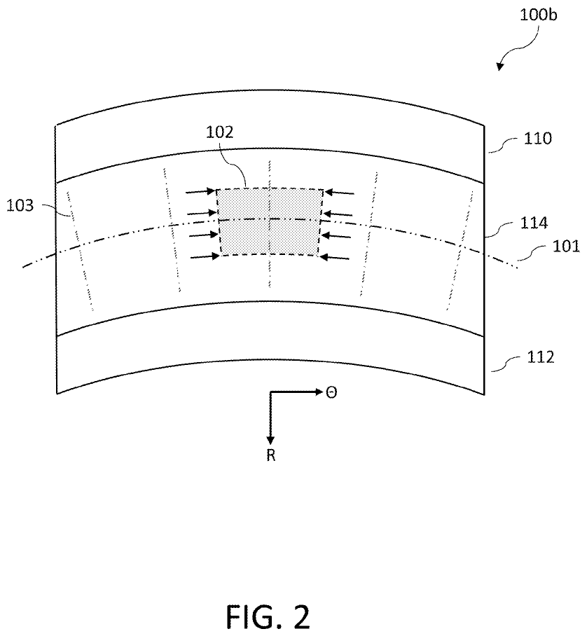

In some cases, the electric field may be uniform across the solid electrolyte 114 in some electrochemical cells. For example, FIG. 1A shows the electric field 103 in the cell 100a is uniformly directed along the X axis. If the entire solid electrolyte 114 is in a compressive stress state, then every portion of the solid electrolyte 114 may be subjected to a compressive stress component oriented along the plane 101. In another example, FIG. 2 shows a cell 100b that has a circular curvature. For the cell 100b, the electric field 103 may be oriented along a radial axis R between the anode 110 and the cathode 112. Accordingly, the portion 102 may in a compressive stress state with at least one stress component oriented along a curved plane 101 defined by a polar axis e and a Z axis orthogonal to the R and e axes). If the entire solid electrolyte 114 is in a compressive stress state, then every portion of the solid electrolyte 114 may be subjected to a compressive stress component located in the plane 101.

However, in some cases, the electric field may vary spatially in a complex manner within the solid electrolyte 114. Although it may be preferable for every portion of the solid electrolyte 114 to be in a compressive stress state with one stress component oriented orthogonal to the electric field direction in that portion of the solid electrolyte 114, this may be challenging to implement in a practical setting. Thus, in some implementations, the desired compressive stress state may be defined with respect to a physical feature of the cell rather than the direction of the driving force for dendrite growth. For example, if the interface between the solid electrolyte 114 and the cathode 112 may be approximated with a plane (e.g., a flat plane as in FIG. 1A, a curved plane as in FIG. 2), the compressive stress state of the solid electrolyte 114 may include a stress component oriented parallel to that plane. The approximation of an interface with a plane may be accomplished, for example, by defining a plane based on three points taken along the interface. A plane may also be defined based on the interface between the anode 110 and the solid electrolyte 114 (or between the cathode 112 and the solid electrolyte 114).

In some implementations, the compressive stress state may include a single stress component. In other words, at least a portion of the solid electrolyte 114 is subjected to a uniaxial compressive stress. In some implementations, the compressive stress state may include two stress components oriented orthogonal to the preferred direction of dendrite growth (e.g., the plane 101 in cells 100a and 100b). Thus, at least a portion of the solid electrolyte 114 is subjected to a biaxial compressive stress.

The magnitude of the orthogonal compressive stress component may affect the degree to which dendrite growth is suppressed and/or the dendrite is deflected. Generally, a higher magnitude compressive stress component may more readily stop dendrite growth or deflect a dendrite to follow more closely along the direction of the compressive stress component. In some implementations, the magnitude of the orthogonal compressive stress component used to suppress and/or deflect dendrite growth may be greater than or equal to about 50 MPa. More preferably, the magnitude of the orthogonal compressive stress component may be greater than or equal to about 100 MPa. Even more preferably, the magnitude of the orthogonal compressive stress component may be greater than or equal to about 150 MPa. It should be appreciated that an upper limit in the compressive stress component may be defined based on the mechanical properties of the solid electrolyte 114. For example, the upper limit may be defined based on the compressive yield strength of the solid electrolyte 114. Thus, in some implementations, the magnitude of the orthogonal compressive stress component may range from about 50 MPa to about 1000 MPa, including all values and sub-ranges in between. More preferably, the magnitude of the orthogonal compressive stress component may range from about 100 MPa to about 1000 MPa, including all values and sub-ranges in between. Even more preferably, the magnitude of the orthogonal compressive stress component may range from about 150 MPa to about 1000 MPa, including all values and sub-ranges in between.

In some implementations, a critical stress may exist at which dendrite growth is stopped or deflected entirely along the direction of the compressive stress component. The critical stress may range between about 50 MPa and about 300 MPa, including all values and sub-ranges in between. More preferably, the magnitude of the compressive stress component may range from about 100 MPa to about 200 MPa, including all values and sub-ranges in between.

The term “about,” when used to describe the magnitude of the orthogonal compressive stress component and the critical stress, is intended to cover variability in the manufacture and/or assembly of a cell with the compressive stress state (see Sections 1.1. and 1.2). For example, “about 100 MPa” may correspond to the following ranges: 99 to 101 MPa (+/−1% variability), 98 to 102 MPa (+/−2% variability), 97 to 103 MPa (+/−3% variability), 96 to 104 MPa (+/−4% variability), 95 to 105 MPa (+/−5% variability), including all values and sub-ranges in between.

For purpose of detection, the magnitude and orientation of the compressive stress in the electrolyte 114 may be determined experimentally, as shown in the experimental study described in Section 2.1, or using analytical or modeling methods known to those skilled in the art. As a non-limiting example, finite-element-modeling (FEM) and other computational methods may be used to model the stress distributions within materials and assemblies of specified geometry, dimensions, materials properties, applied mechanical load, time- and stress-dependent deformation behavior, and thermal history.

The effect of the compressive stress state on dendrite growth and propagation may also be evaluated, for example, by assessing the change in direction of the dendrite. For many solid-state cells, the solid electrolyte may be formed as a thin film. Said another way, the width of the solid electrolyte 114 along the Y axis may be appreciably larger than the thickness of the solid electrolyte 114 along the X axis in FIG. 1A. Thus, it may be preferable to configure the compressive stress state to deflect the dendrite at an appreciably large angle Θ. For example, the propagation angle of the dendrite 191 within the compressive stress state, Θ, may range from about 80 degrees to about 90 degrees, including all values and sub-ranges in between. More preferably, the angle, Θ, may range from about 85 degrees to about 90 degrees, including all values and sub-ranges in between. Even more preferably, the angle, Θ, may range from about 89 degrees to about 90 degrees, including all values and sub-ranges in between. It should be appreciated that the foregoing ranges may also be defined with respect to the direction that the compressive stress state is applied (i.e., |90 [deg]-Θ[deg]|). For example, the value 190 [deg]-Θ[deg]j may be less than or equal to about 10 degrees. In some implementations, the change in the propagation angle of the dendrite 191 with and without the compressive stress state (i.e., |Θ−β|) may range from about 10 degrees to about 90 degrees, including all values and sub-ranges in between.

The term “about,” when used to describe the angle, β, or the value |90 [deg]-Θ[deg]|, is intended to cover the precision with which this angle may be measured or calculated (see Sections 2.1. and 2.2). For example, “about 90 degrees” may correspond to the following ranges: 89.1 to 90.9 degrees (+/−1% variability), 88.2 to 91.8 degrees (+/−2% variability), 87.3 to 92.7 degrees (+/−3% variability), 86.4 to 93.6 degrees (+/−4% variability), 85.5 to 94.5 degrees (+/−5% variability), including all values and sub-ranges in between.

The compressive stress state may also include a stress component oriented parallel to the preferred direction of dendrite growth, which may be detrimental to suppressing and/or deflecting dendrite growth. For example, conventional solid-state electrochemical cells are often subjected to a stack pressures (i.e., a pressure oriented normal to the interface between the anode 110 and the solid electrolyte 114 and/or the interface between the electrolyte 114 and the cathode 112). A stack pressure is often used to provide persistent contact at the anode/solid-electrolyte interface, thus increasing the current densities of solid-state cells. However, a stack pressure may also promote dendrite propagation towards the cathode (see Section 2.4).

Thus, in some implementations, if the compressive stress state includes a stress component oriented parallel to the preferred direction of dendrite growth, the magnitude of the parallel stress component may be configured to be small. For example, the magnitude of the parallel stress component (also referred to herein as the stack pressure) may be less than or equal to about 50 MPa. More preferably, the magnitude of the parallel stress component may be less than or equal to about 20 MPa. Even more preferably, the magnitude of the parallel stress component may be less than or equal to about 10 MPa. In some implementations, the cells disclosed herein may not be subjected to any stack pressure. The term “about,” when used to describe the magnitude of the parallel compressive stress component (i.e., the stack pressure), is intended to cover is intended to cover variability in the manufacture and/or assembly of a cell with the compressive stress state (see Sections 1.1. and 1.2). For example, “about 100 MPa” may correspond to the following ranges: 99 to 101 MPa (+/−1% variability), 98 to 102 MPa (+/−2% variability), 97 to 103 MPa (+/−3% variability), 96 to 104 MPa (+/−4% variability), 95 to 105 MPa (+/−5% variability), including all values and sub-ranges in between.

The compressive stress state may generally be introduced in any solid electrolyte capable of supporting stress without deformation including, but not limited to, single crystal solid electrolytes, polycrystal solid electrolytes, dense solid electrolytes, porous solid electrolytes, multiphase electrolytes comprising at least a solid phase, and semi-solid electrolytes comprising a solid phase and a liquid phase. See Sections 1.2 and 2.3 for further examples of solid electrolyte materials.

It should be appreciated that the compressive stress state may be generated in a variety of cell architectures. These architectures include, but are not limited to, a laminate structure with planar interfaces (e.g., cell 100a), and a reticulated structure in which one or more components have a periodic or aperiodic variation in dimension. It should also be appreciated that the electrolyte 114 in which a compressive stress is induced may have a uniform thickness or a varying thickness. The electrolyte 114 may be planar or nonplanar.

It should also be appreciated that the compressive stress state may also vary depending on the deformation of the solid electrolyte 114 when subjected to the various stress components. This deformation may include, but is not limited to, elastic deformation, plastic deformation, and creep. This deformation may also be affected by any slip or sliding of adjacent materials at their respective interfaces, and the relative dimensions of the components (e.g., the relative thicknesses f electrolyte layers and electrodes or other adjacent materials). For example, a thin layer of solid electrolyte will bear the majority of the stress when attached to a thick layer of electrode.

### 1.1 External Mechanical Loads to Generate a Compressive Stress State

The compressive stress state may be introduced in the solid electrolyte 114 by applying an external mechanical load to the cells disclosed herein. In some implementations, this may be accomplished using a casing. Specifically, the casing may include a coupling mechanism to securely couple the casing to the cell and, simultaneously, apply a mechanical to load to compress the solid electrolyte 114.

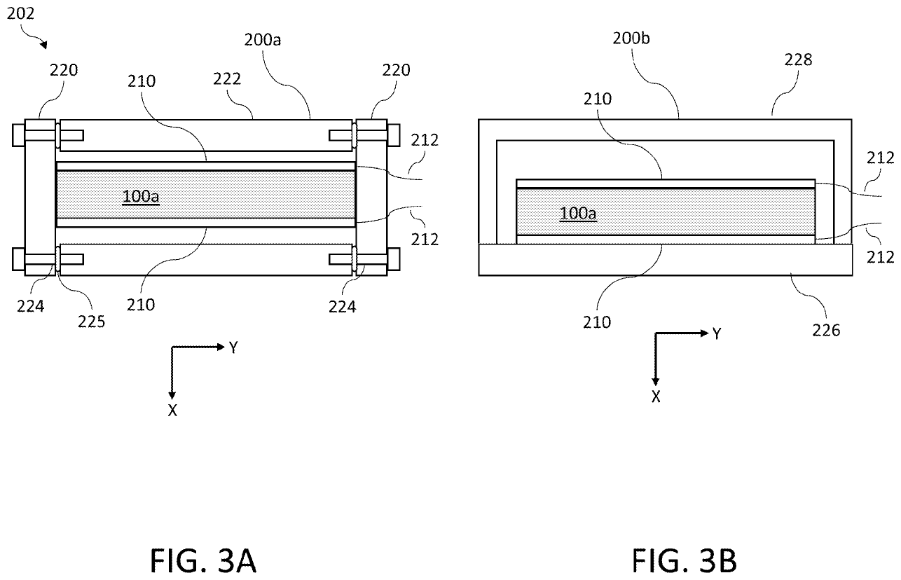

In one example, FIG. 3A shows a casing 200a with a clamp 202 to apply a mechanical load to the cell 100a. As shown, a pair of plates 220 may be coupled to a frame 222 to form an enclosure containing the cell 100a. The cell 100a may further be securely coupled to a pair of current collectors 210 with wiring 212 to electrically couple the cell 100a, for example, to an external load. The plates 220 may be disposed on opposing sides of the cell 100a and securely coupled to the frame 222 via at least one fastener 224 and a corresponding gasket 225. The plates 220 make physical contact with respective sides of the cell 100a such that, as the fasteners 224 are tightened, a compressive load is applied to the cell 100a along the Y axis, which is orthogonal to the electric field (see FIG. 1A). In some implementations, the gaskets 225 may provide sufficient compliance such that the fasteners 224 may be tightened or loosened to adjust the compressive load applied to the cell 100a without causing the plates 220 to become loose from the frame 222. It should be appreciated that the fasteners 224 are one non-limiting coupling mechanism and that other coupling mechanisms may be used to couple the clamping plates 220 to the enclosure 222 including, but not limited to, a snap-fit connector, and a nut/bolt fastener.

In another example, FIG. 3B shows casing 200b with a support plate 226 that provides a surface onto which the cell 100a may be coupled to the plate 210 (e.g., via bonding, an adhesive). As shown, the cell 100 may be securely coupled to a pair of current collectors 210 with wiring 212 to electrically couple the cell 100a, for example, to an external load. The assembly of the cell 100a and the current collectors 210 may be securely coupled to the surface of the support plate 226, via an adhesive or a bonding material (e.g., a thermoplastic material for thermal bonding). As shown, a cover 228 may also be coupled to the support plate 226 to form an enclosure containing the cell 100a.

A compressive stress may be applied to the cell 100a in several ways. In one example, the support plate 210 may create a thermal expansion mismatch with the cell 100a and the current collector 210. This may be accomplished by forming the support plate 210 from a material that has a thermal expansion coefficient greater than the components of the cell 100a and/or the current collector 210. For example, the support plate 210 may be formed of aluminum. During assembly, the cell 100a and the current collector 210 may be joined to the support plate 210 at an elevated temperature and thereafter cooled to a lower temperature. The support plate 210 may contract more than the cell 100a and the current collector 210, thus generating a compressive residual thermal stress in the cell 100a.

In another example, the support plate 226 may have a convex surface to support the cell 100a and the current collector 210. When the cell 100a and/or the current collector 210 are attached to the convex surface of the support plate 226, the cell 100a may be bent in shape thus causing an inner portion of the cell 100a closer to the convex surface to be subjected to a compressive stress and an outer portion of the cell 100a to be subjected to a tensile stress. The components of the cell 100a may be arranged such that the solid electrolyte 114 is subjected to the compressive stress.

### 1.2 Residual Stresses to Generate a Compressive Stress State

The compressive stress state may also be introduced in the solid electrolyte 114 by generating a residual stress within the cells disclosed herein including the electrolyte 114. In some implementations, the residual stress may be introduced, for example, during manufacture or assembly of the cell. In some implementations, the residual stress may be introduced after the cell is fabricated, e.g., as a post processing step.

In some implementations, a compressive thermal residual stress may be generated within the cell to provide the desired compressive stress state in the solid electrolyte 114. This may be accomplished using a thermal expansion mismatch between the solid electrolyte 114 and another component in the cell. For example, a thermal expansion mismatch may be introduced between the solid electrolyte 114 and the cathode 112 in the cell 100a of FIG. 1A by selecting a material for the cathode 112 that has a coefficient of thermal expansion greater than the coefficient of thermal expansion of the solid electrolyte 114. If the solid electrolyte 114 is formed on the cathode 112 (e.g., via bonding, deposition) at an elevated temperature and subsequently cooled to a lower temperature, the difference in the coefficient of thermal expansion between the solid electrolyte 114 and the cathode 112 may cause the cathode 112 to thermally contract more than the solid electrolyte 114. This, in turn, leads to a compressive thermal residual stress in the solid electrolyte 114 and a tensile thermal residual stress in the cathode 112. It should be appreciated that these thermal residual stresses may also be generated if the cathode 112 is formed on the solid electrolyte 114 (e.g., via bonding, deposition).

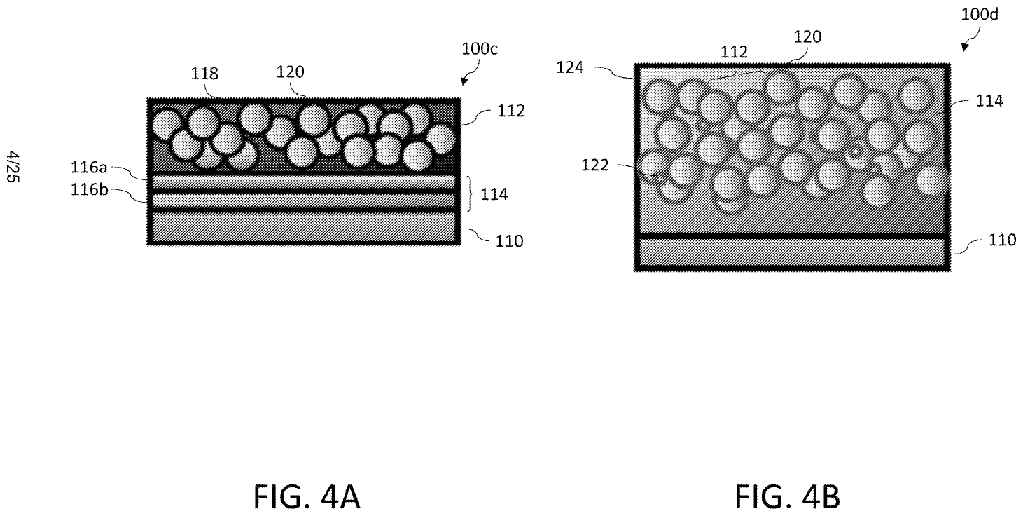

In another example, FIG. 4A shows a cell 100c that includes a composite solid electrolyte 114. Specifically, the electrolyte includes a first layer 116a of a first solid electrolyte and a second layer 116b of a second solid electrolyte. The first and second solid electrolytes may correspond to different electrolyte materials with different coefficients of thermal expansion. Thus, if the first and second solid electrolytes are joined together at an elevated temperature and thereafter cooled, a compressive thermal residual stress may be introduced in the solid electrolyte having the lower coefficient of thermal expansion.

It should be appreciated that the anode 110 and/or the cathode 112 may also be a composite material. For example, FIG. 4A shows the cathode 112 may be a composite that includes electrochemically active particles 120 disposed in an electrically conductive matrix 118. The matrix 118 may be formed of carbon. It should also be appreciated that the layered composite electrolyte 114 in FIG. 4A is a non-limiting example. In some implementations, the electrolyte 114 may include more than two layers of electrolyte. Each adjacent layer may further be formed of a different electrolyte material. More generally, the electrolyte 114 may include two or more solid electrolyte materials mixed together with any desired morphology.

For example, the electrolyte 114 may include a solid electrolyte matrix formed of a first electrolyte material and a plurality of solid electrolyte particulates formed of a second electrolyte material suspended with the matrix. In another example, the electrolyte 114 may include a solid electrolyte matrix formed of a first electrolyte material and a plurality of solid electrolyte wires formed of a second electrolyte material suspended with the matrix. The wires and/or particles may be distributed in the matrix in a manner that produces the desired compressive stress state in either the matrix or the wires and/or particles. For example, the wires and/or particles may be located in only one portion of the matrix, thus an effective coefficient of thermal expansion for that portion may differ from the remaining portion of the matrix. This may effectively create two layers of solid electrolyte.

In addition to generating a thermal residual stress, a mismatch in the mechanical properties between different solid electrolytes may also modify the manner in which a dendrite propagates. For example, a composite electrolyte may include a first solid electrolyte formed of a soft elastic material and a second solid electrolyte formed of an elastically stiffer material. In another example, a composite electrolyte may include a first solid electrolyte formed of a brittle material and a second solid electrolyte formed of a ductile material.

In yet another example, FIG. 4B shows a cell 100d that includes a composite cathode/electrolyte 124 joined to the anode 110. The composite 124 includes electrochemically active particles 120 forming a cathode 112 in an electrolyte matrix 114. Additionally, electrically conductive particles 122 (e.g., formed of carbon) may also be disposed within the electrolyte matrix 114. The composite electrolyte 114 in the cell 100d may be formed, for example, by co-sintering the cathode 112 and the electrolyte 114. In the cell 100d, the desired compressive stress state may be generated in the electrolyte matrix 114 based on differences in the coefficient of thermal expansion between the electrochemically active particles 120, the electrolyte matrix 114, and the electrically conductive particles 122 and/or the volumetric distribution of the particles 120 and 122 in the matrix 114. For example, the particles 120 and 122 may be disposed in one portion of the matrix 114, thus an effective coefficient of thermal expansion for that portion may differ from the remaining portion of the matrix 114.

For the foregoing examples, various materials may be used to form the electrolyte 114 and/or the cathode 112. The solid electrolyte 114 may be formed of one or more materials including, but not limited to, an oxide electrolyte (e.g., LLZTO), a crystalline sulfide electrolyte (e.g., Li₁₀GeP₂Si₂ (LGPS)), and a lithium super ionic conductor (LISICON) electrolyte (e.g., Li₁₊ₓAlₓTi₂₋ₓ(PO₄)₃(LATP)). The cathode 112 may be formed of one or more materials including, but not limited to, Nickel Manganese Cobalt Oxide (NMC) and Lithium Iron Phosphate (LFP).

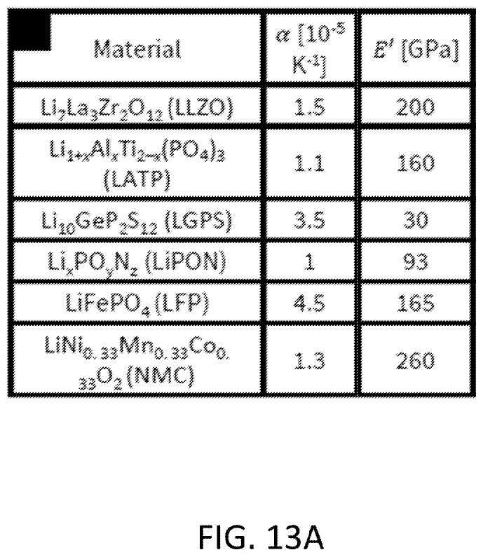

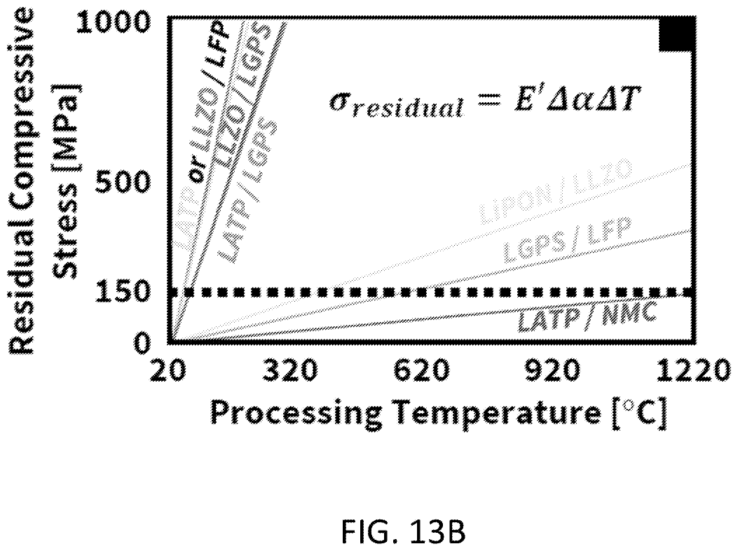

The thermomechanical properties for some of the foregoing materials are provided in FIG. 13A. As shown, LFP possesses a substantially higher coefficient of thermal expansion than other cathodes, making it particularly amenable for engineering residual stresses in a laminated architecture. For example, if the cathode 112 is formed from LFP and the electrolyte 114 is formed from oxide and/or LISICON electrolytes, the desired compressive residual stresses may be generated using processing temperatures on the order of a few hundred degrees Celsius. Such temperatures are readily accessible via conventional slurry-based processing methods for depositing cathode layers onto fully dense solid-electrolytes. Cold-sintering techniques for LISICON and oxide electrolytes may also be used to facilitate densification of a powder-based electrolyte at 100° C.-200° C., which, in turn, permits the synthesis of electrolytes directly upon full-dense cathode films at lower temperatures. In another example, sulfide electrolytes may be joined to LFP at processing temperatures greater than 515° C. to achieve a residual stress of, for example, 150 MPa. This temperature is within the range of conventional solid-state reaction synthesis for the sulfides (500° C.-900° C.). For a multilayered electrolyte design (e.g., see the composite electrolyte 114 in the cell 100c), sulfide electrolytes appear particularly attractive to pair with oxides due to the sulfide's relatively large coefficient of thermal expansion. The combination of a sulfide electrolyte with another material (e.g., LISICON/sulfide and oxide/sulfide) may achieve sufficient residual compressive stresses when manufactured at only a few hundred degrees Celsius. This temperature range is not only amenable to cold-sintering-based methods as discussed for oxides and LISICON electrolytes, but also falls well within range of wet-chemical synthesis techniques producing dense electrolytes (˜100° C.-300° C.). In yet another example, LiPON films deposited on top of oxide electrolytes also offer substantial compressive stresses across a range of temperatures due to LiPON's low coefficient of thermal expansion.

More generally, a compressive thermal residual stress may be introduced in the solid electrolyte 114 via a thermal expansion mismatch between any two components of the cell, which may or may not include the electrolyte 114. These components include, but are not limited to, the electrodes (e.g., the anode 110, the cathode 112), the electrolyte 114, the current collectors (e.g., the current collectors 210), and any supporting materials that may or may not have any electrical function (e.g., the casing 200). In some implementations, an electrically inert substrate may be added to the cell for the purpose of altering the stress state of the solid electrolyte 114. For example, a substrate formed of an electrically insulating polymer may be joined to the cell 100a (e.g., the anode 110, the cathode 112) at an elevated temperature and subsequently cooled to induce a compressive stress in at least the solid electrolyte 114.

Various processes with time-temperature cycles may be used to introduce the thermal residual stress. In one example, a laminate described above with respect to FIG. 1A and FIG. 4A may be formed at an elevated temperature such that no stresses are imparted to the cell at the elevated temperature (e.g., all the stresses are relaxed). After assembly, the cell may be cooled to room temperature without any process to relax the stresses. Other example processes include, but is not limited to, quenching, rapid cooling, continuous cooling, linear cooling rate, nonlinear cooling rate, oscillatory cooling and heating, cooling to a lower temperature followed by heating to operating temperature for the device, cryogenic annealing, and the like.

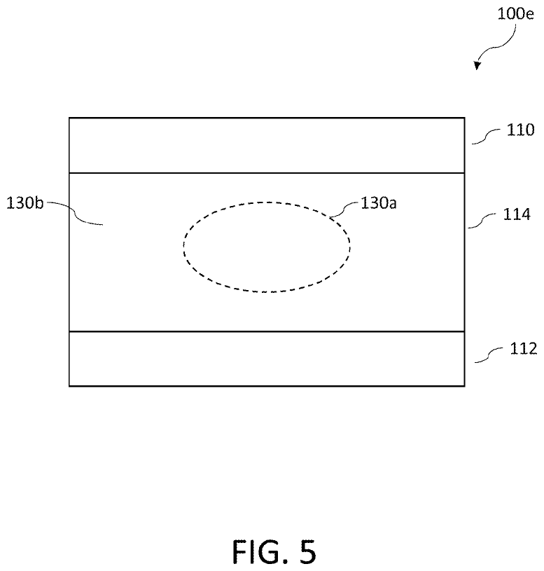

In some implementations, a residual stress may be introduced in the solid electrolyte 114 by locally reducing a portion of the solid electrolyte 114 via an electrochemical or chemical reaction. The local reduction of the solid electrolyte 114 may produce an electrolyte phase with a different volume. The change in volume of the electrolyte phase may generate a residual stress. For example, FIG. 5 shows an example cell 100e where the solid electrolyte 114 is initially formed of a first electrolyte phase. A portion 130a of the first electrolyte phase may be subjected to an electrochemical or chemical reaction, thus producing a second electrolyte phase. If, for example, the second electrolyte phase has an expanded volume, the expansion of the portion 130a may be limited by the surrounding portion 130b of the remaining first electrolyte phase. This, in turn, may generate a compressive residual stress acting on the portion 130a. It should be appreciated that solid electrolyte 114 may include multiple portions 130a of the second electrolyte phase. In some implementations, the entirety of the solid electrolyte 114 may be reduced to form the second electrolyte phase. In this case, a compressive stress may arise between the electrolyte 114 and the anode 110 and/or the cathode 112.

It should be appreciated that, in some implementations, the desired compressive stress state in the cell and, in particular, the solid electrolyte 114 may be achieved using a combination of an externally applied load and a residual stress generated during manufacture and/or assembly of the cell.

### 2. An Example Demonstration of Li Dendrite Deflection

In this section, an experimental study and a fracture mechanics model are presented that elucidate the interaction between the electrochemical and mechanical forces underlying metal-dendrite propagation. Specifically, the propagation of lithium metal dendrites through an example solid electrolyte of Li_{6.75}La₃Zr_{1.75}Ta_{0.25}O₁₂ (LLZTO) was evaluated under sequential and simultaneous electrochemical and mechanical stimulation. The mechanical stress state to appreciably stop and/or deflect dendrites was further predicted using fracture mechanics and compared to experimental results.

It was shown that a stress-based approach to suppress or, in some instances, mitigate metal dendrite failure in a solid-state electrochemical cell is feasible. In particular, metal dendrites growing through a solid electrolyte may be deflected by an imposed stress. For Li metal dendrites growing in the LLZTO electrolyte, a compressive in-plane stress is observed to deflect the dendrite growth trajectory away from the electric field lines towards the compressive loading axis. The results further show that a critical stress of about 150 MPa applied orthogonally to the electric field vector is sufficient to deflect the dendrites in order to avoid a short circuit regardless of the initial growth direction of the dendrites. The experiments were conducted under conditions where dendrite growth due to internal reduction of lithium ions was possible, yet no evidence of such growth was observed when stress-deflection was active. Thus, the results show that metal dendrite growth for the materials tested is determined primarily by mechanical fracture rather than the internal reduction of lithium ions to lithium metal.

The insight gained from these results was also used to devise a design strategy to deflect and/or stop dendrites using residual compressive stresses introduced into the electrolyte during the fabrication of a solid-state electrochemical cell. For example, the desired compressive stress state in the solid electrolyte may be generated using residual thermal stresses resulting from a thermal expansion mismatch between constituent layers of a laminate solid-state electrochemical cell architecture. Accordingly, different combinations of materials and processing approaches are discussed to achieve the desired residual thermal stresses in the solid electrolyte.

### 2.1 Response of Metal Dendrites to Electrical and Mechanical Stimulation

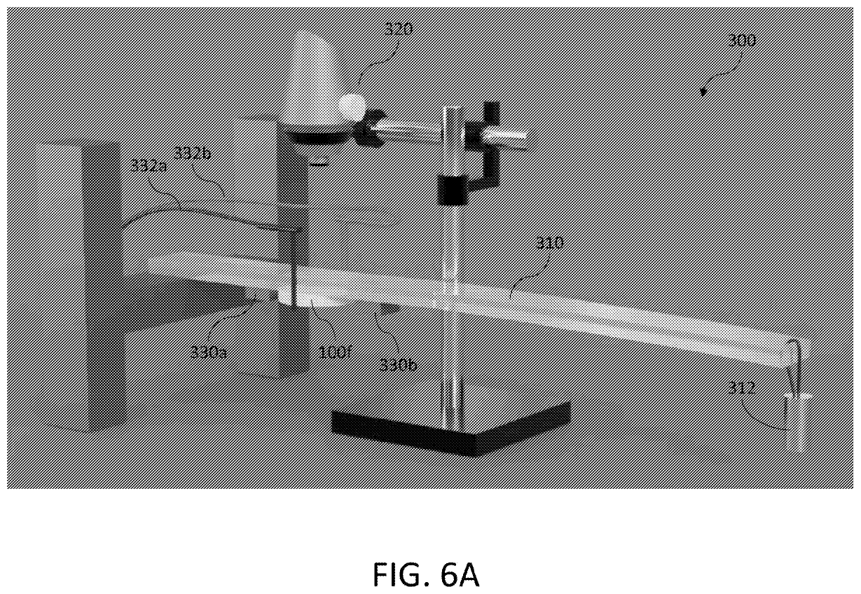

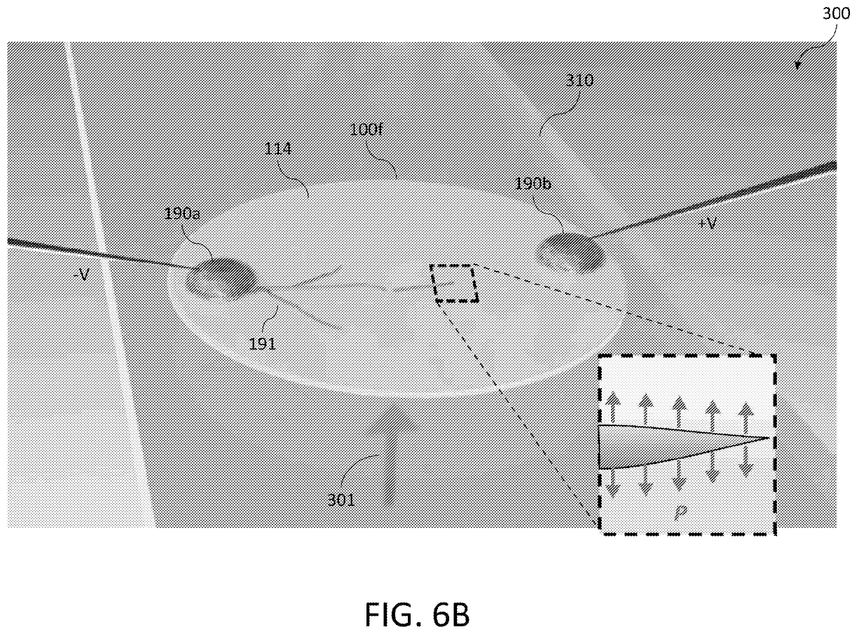

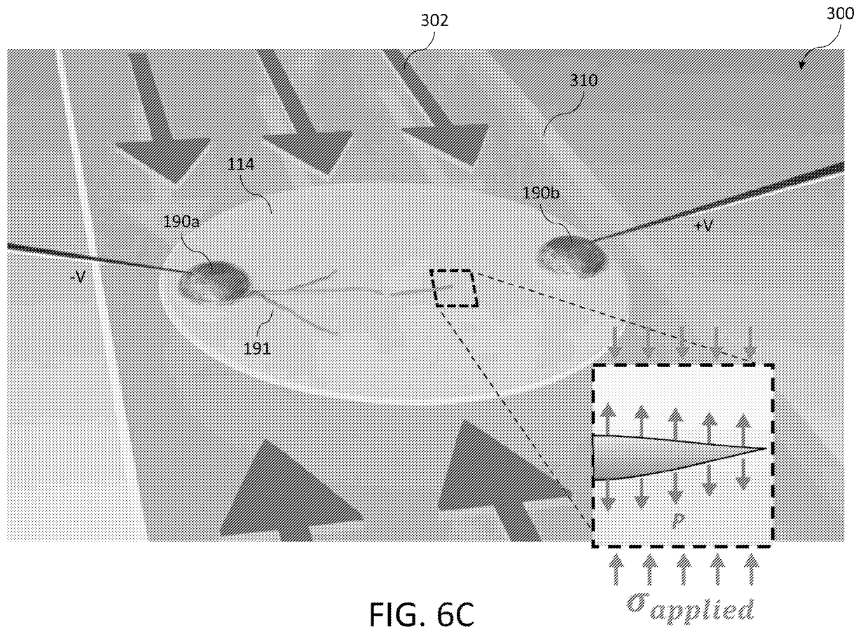

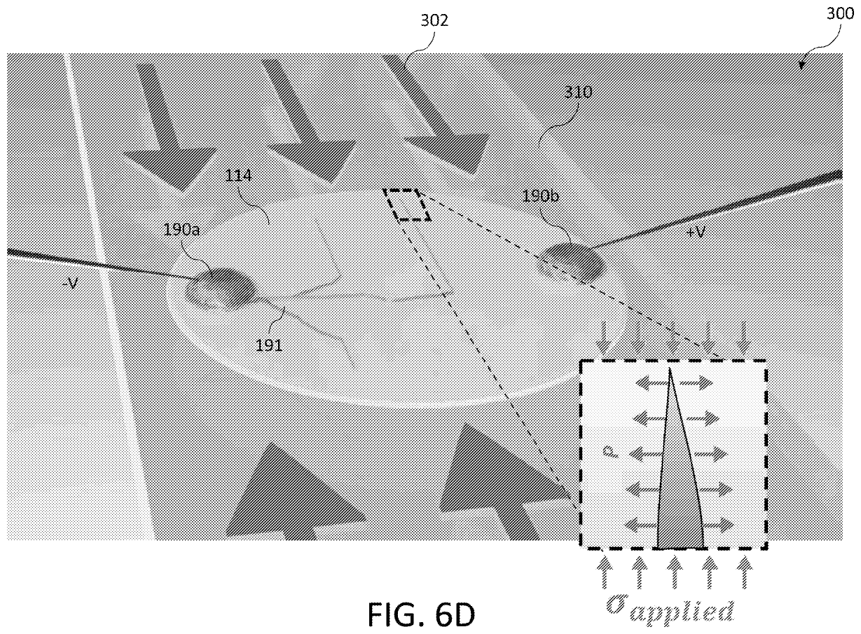

As described herein, if dendrite growth through a solid electrolyte is primarily driven by plating-induced pressure (see P in FIG. 6B), a compressive stress may be superimposed onto the solid electrolyte (see σ_{applied} in FIG. 6C) to balance internal stress buildup and appreciably reduce or, in some instances, mitigate penetration of metal dendrites through the solid electrolyte. This stress compensation mechanism was investigated by mechanically applying a compressive stress to an example electrolyte. However, it should be appreciated that a compressive stress may be generated in other ways. For example, residual thermal stresses or chemically induced stresses may also be used to balance internal stress buildup within the solid electrolyte.

FIGS. 6A-6D show a testing apparatus 300 to study the stress compensation mechanism in an example solid-state cell 100f. The solid-state cell 100f in this demonstration included two lithium metal electrodes 190a and 190b adhered to the surface of a thin disc of electrolyte 114. The electrolyte disc 114 was formed of LLZTO and had a diameter of about 1.27 cm (½ inch). As shown in FIG. 6B, lithium dendrites 191 were plated through the plane of the electrolyte 114. The testing apparatus 300 included electrical connectors 332a and 332b to electrically couple the electrodes 190a and 190b, respectively, to an electrical power source (not shown).

The solid-state cell 100f was rigidly mounted on a cantilever beam 310 (see FIGS. 6A and 6B) and oriented such that bending the beam 310 resulted in an applied stress σ_{applied} orthogonal to the electric field direction (see direction 302 in FIG. 6C). The beam 310 was rigidly coupled at one end to a support structure and free at the other end. A weight 312 was attached to the free end of the beam 310 to controllably bend the beam 310 and generate a compressive strain in the beam 310 and the cell 100f, which, in turn, induces a compressive stress in the cell 100f. Different weights 312 were attached to the beam 310 to adjust the magnitude of the applied strain and stress. The testing apparatus 300 further included a pair of strain gauges 330a and 330b attached to the beam 310 and disposed on opposite sides of the solid-state cell 100f. The strain gauges 330a and 330b each measure bending-induced strain in real time. The strain data, in turn, was used to determine the strain induced in the electrolyte disc 114 and estimate the magnitude of the applied stress. The beam 310 was further formed of a transparent material to allow operando optical microscopy while the current and the mechanical load applied to the solid-state cell 100f were varied independently. For example, FIG. 6A shows an optical microscope 320 disposed over a portion of the beam 310 to acquire imagery of dendrites 191 propagating through the electrolyte 114 (see direction 301 in FIG. 6B).

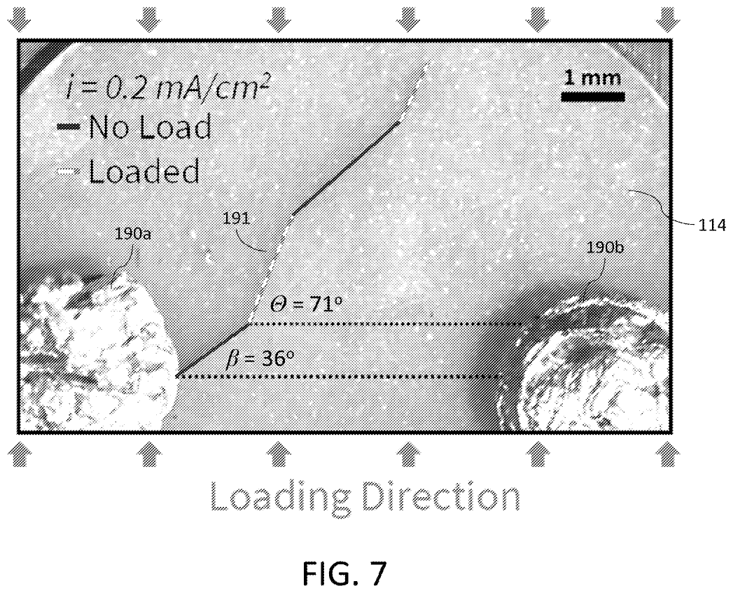

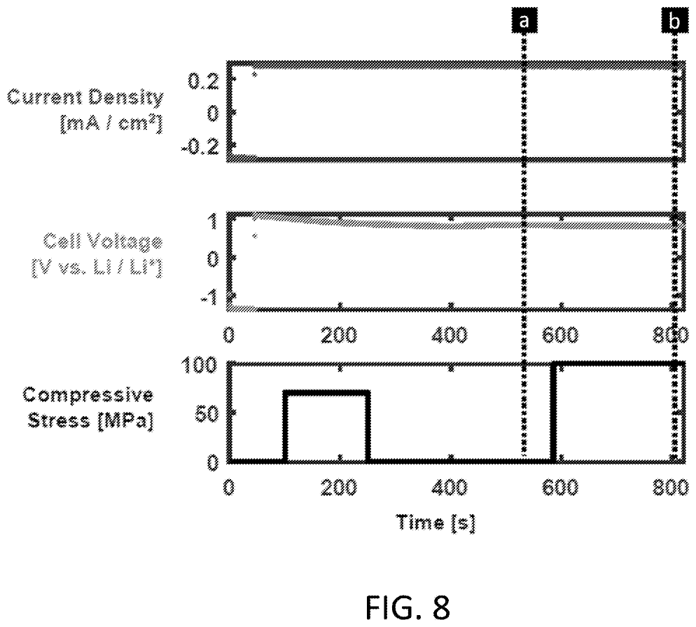

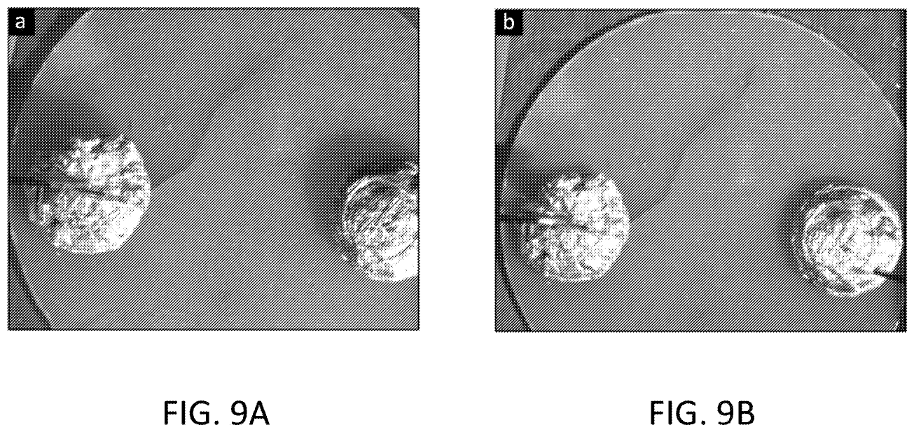

It was observed that metal dendrites 191 exhibited a correlated response to applied mechanical loads (FIGS. 7-11). FIG. 7 shows the results of an experiment using a 90 μm thick LLZTO electrolyte disc. In this experiment, a 0.2 mA/cm² current density (i.e., the current divided by the initial Li metal electrode area) was applied to the solid-state cell 100f to generate and propagate a dendrite 191. The plating of Li metal occurred at voltages within the LLZTO electrolyte window (voltage and current data available in FIG. 8). As the dendrite 191 propagated through the electrolyte 114, the cell 100f was subjected to either 70 MPa of applied compression or no load. The portion of the dendrite 191 that formed under no applied load is highlighted with a solid line and the portion of the dendrite 191 that formed under an applied load is highlighted with a dash line. FIG. 8 shows the current density, the cell voltage, and the compressive stress applied during this experiment. For this experiment, a strain gauge was fixed onto the cantilever beam 310 after the experiment, and the strain in the cell 100f was deduced based on the measured strain under identical loading conditions (i.e., the same weight applied to the end of the cantilever beam 310). Micrographs with no highlighting are also shown in FIGS. 9A and 9B. As shown in FIG. 7, when the load was applied, a clear deflection of the dendrite 191 towards the loading axis was observed. When the load was removed, the dendrite 191 turned back towards its original propagation direction.

The tendency for the dendrites 191 to align with the applied load is consistent with the propagation of a pressurized crack. In particular, continuous metal plating results in a pressure buildup within the metal protrusion. This, in turn, results in a pressure on the surface of the flaw (P in FIG. 6B), which drives propagation of the metal dendrite. Compressive forces (i.e., σ_{applied} in FIG. 6C) may thus act to close cracks and inhibit propagation perpendicular to the axis of compression. Moreover, under increased load, cracks turn towards the axis of compression, as observed in FIG. 7.

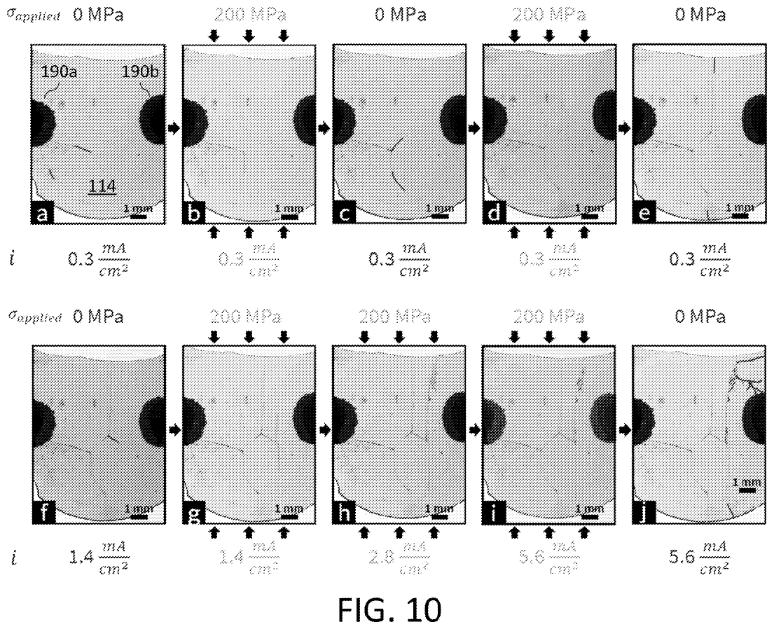

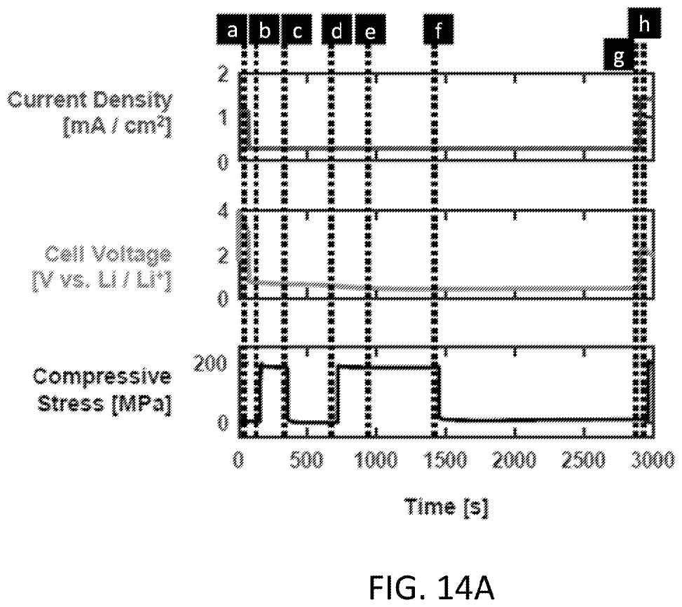

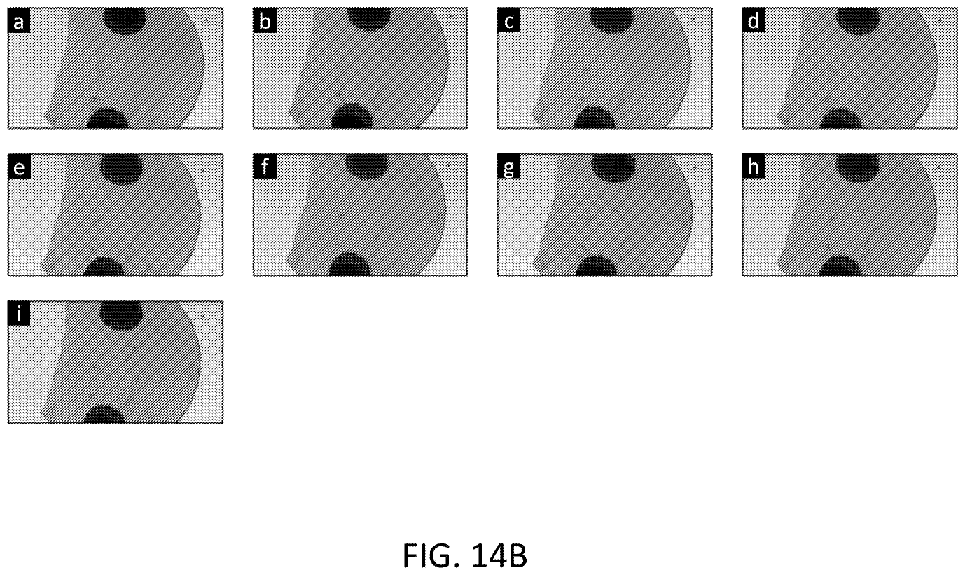

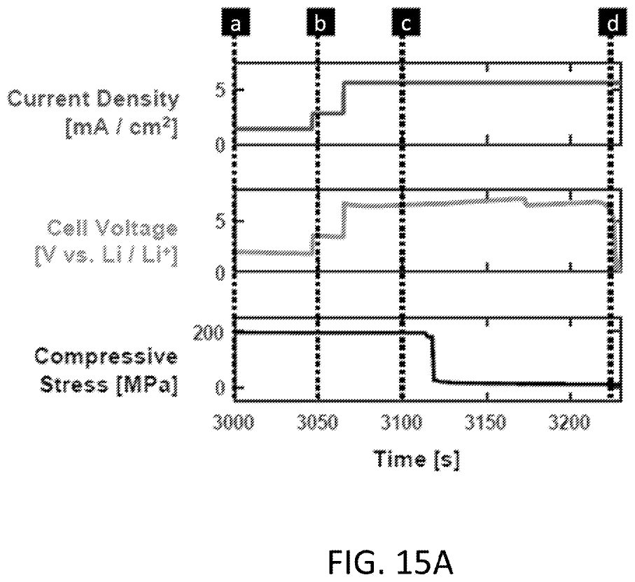

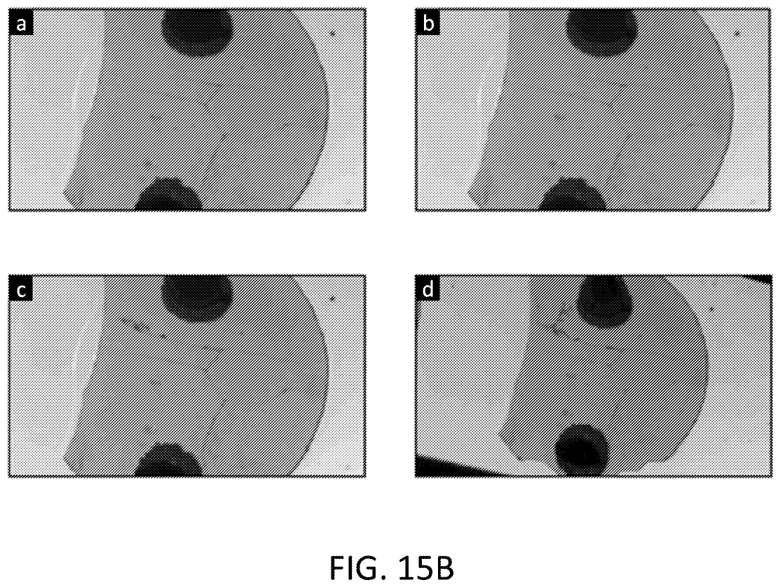

As the applied load increases, the dendrites 191 may thus deflect into closer alignment with the loading axis. To demonstrate this, another experiment was performed using a 30 μm thick electrolyte disc, as shown in FIG. 10. For this experiment, metal dendrites were initiated at a 1.1 mA/cm² galvanostatic current density using the cell configuration from FIGS. 6A-6D. Dendrite growth-segments are highlighted in each frame a-j. The sequence a-j is also chronological. The plating of Li metal occurred at voltages within the LLZTO electrolyte stability window (voltage and current data available in FIGS. 14A and 15A). The electrolyte disc was successively loaded (by applying a 200 MPa compressive load) and unloaded as metal dendrites propagated under either a constant galvanostatic current density of 0.3 mA/cm² (see a-e in FIG. 10) or higher current densities ranging from 1.4 mA/cm² to 5 mA/cm² (see f-j in FIG. 10). The plating of Li metal occurred at voltages within the LLZTO electrolyte window (voltage and current data available in FIGS. 14A and 15A).

In this experiment, the applied 200 MPa compressive loads produced dendrite growth nearly aligned with the loading direction, even for current densities up to 5 mA/cm² (see frames b, d, g-i). In other words, the direction along which the metal dendrite propagated turned by about 90 degrees to align with the loading axis. Once the load was removed, the dendrites 191 repeatedly grew towards the stripping electrode (see frames a and c). In some cases, dendrites that propagated to the edge of the electrolyte disc 114 appeared to stop growing (see frame e). This behavior continued until the dendrites electrically short the cell 100f (see frame j in FIG. 10). This observation demonstrates that compressive stresses may appreciably prolong the lifetime of the cell before an electrical short occurs or, in some instances, prevent electrical shorting outright.

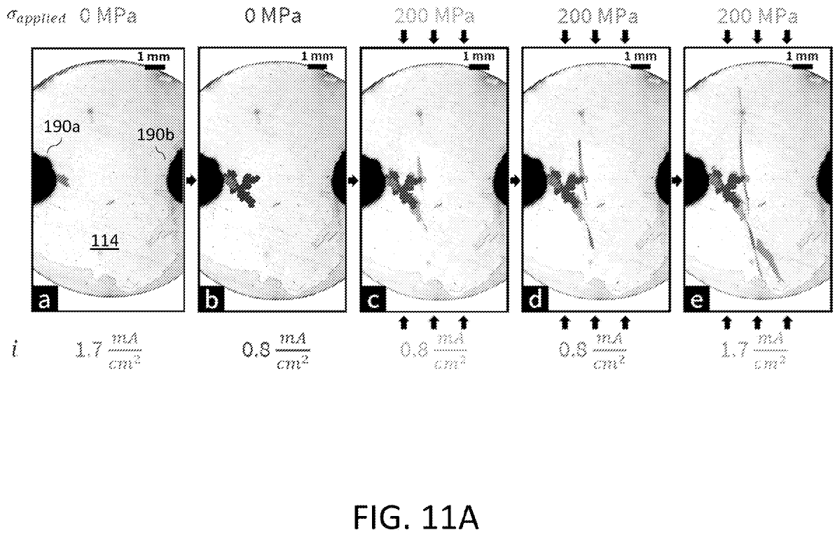

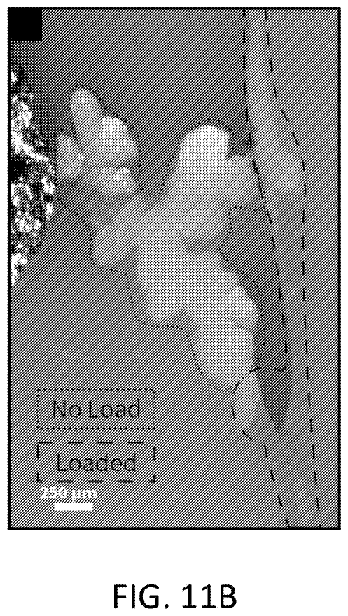

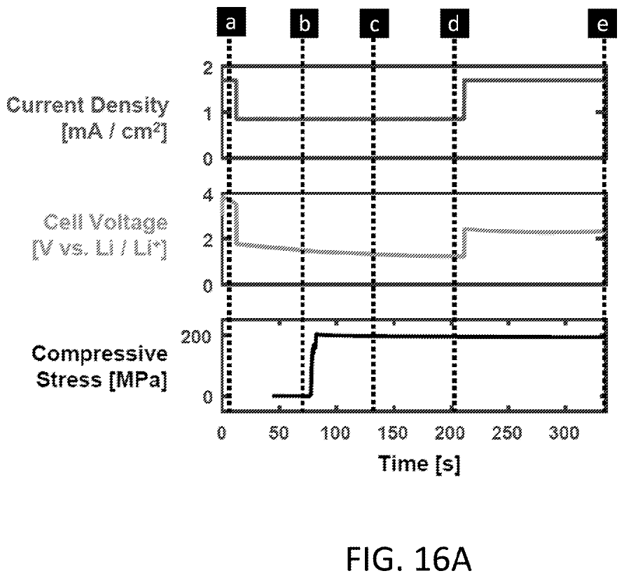

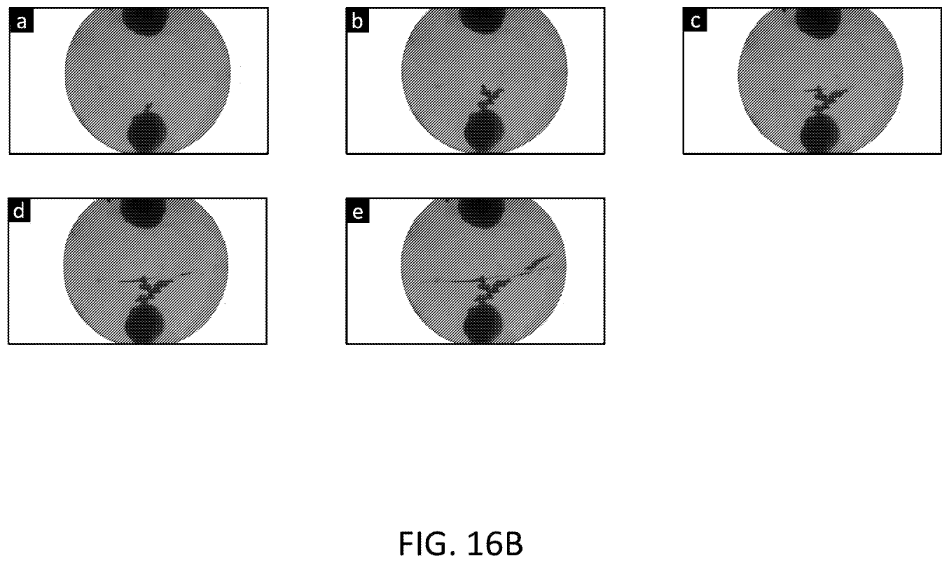

Experiments were also performed using thicker electrolyte samples with similar results. In FIG. 11A, metal filaments in a thicker solid electrolyte disc (250 μm, as compared to 30 μm as in FIG. 10) were also observed to deflect under load. For this experiment, metal dendrites were initiated at a 1.7 mA/cm² galvanostatic current density using the cell geometry shown in FIGS. 1A-1D. The plating of Li metal occurred at voltages within the LLZTO electrolyte window (voltage and current data available in FIG. 16A).

The frames a-e demonstrate the progressive growth, deflection, and arrest of dendrites as the load and current density across the cell are varied. As shown, the dendrites in FIG. 11A are shown to have multiple branches giving a leaf-like appearance. Despite the differences in initial dendrite morphology, the application of a mechanical load deflected the dendrites in a similar manner. In particular, c-e of FIG. 11A show growing dendrites were deflected towards the loading axis after the mechanical load was applied with the crack plane oriented normal to the page (see the metal enclosed by the dashed line in FIG. 11B). This result further shows compressive stresses may be used to appreciably reduce or, in some instances, mitigate dendrite propagation in electrolyte samples of similar thickness to those commonly used.

The foregoing experiments showed that compressive stresses may impact both the propagation direction and the orientation of metal dendrites in solid electrolytes. The deflection increases with the magnitude of the load. For example, a 70 MPa load produced a small deviation in the dendrite propagation direction. However, larger applied loads (σ_{applied}=200 MPa) produced dendrite growth nearly parallel to the loading axis. In this manner, compressive loads may deflect metal dendrites to the extent that electrical short-circuiting of the solid electrolyte is completely averted. Moreover, the direction of propagation may be changed by an imposed stress field for any initial orientation of a growing dendrite.

### 2.2 Fracture Mechanics Model for Dendrite Deflection

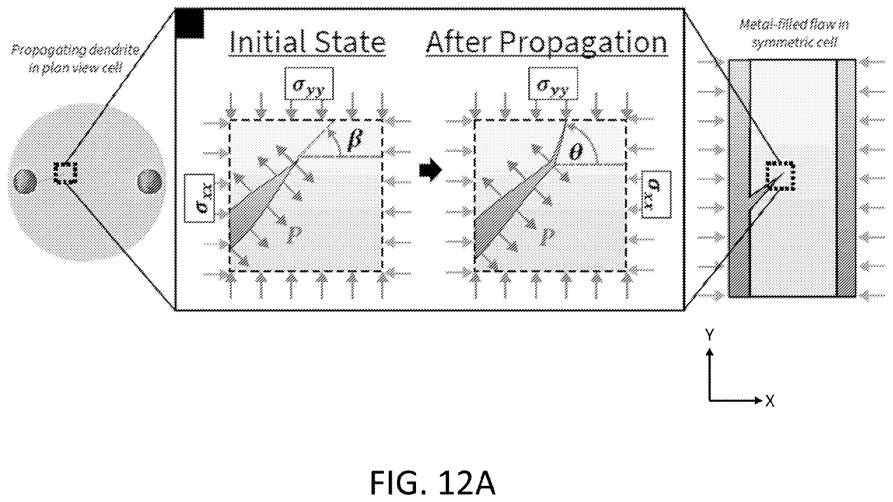

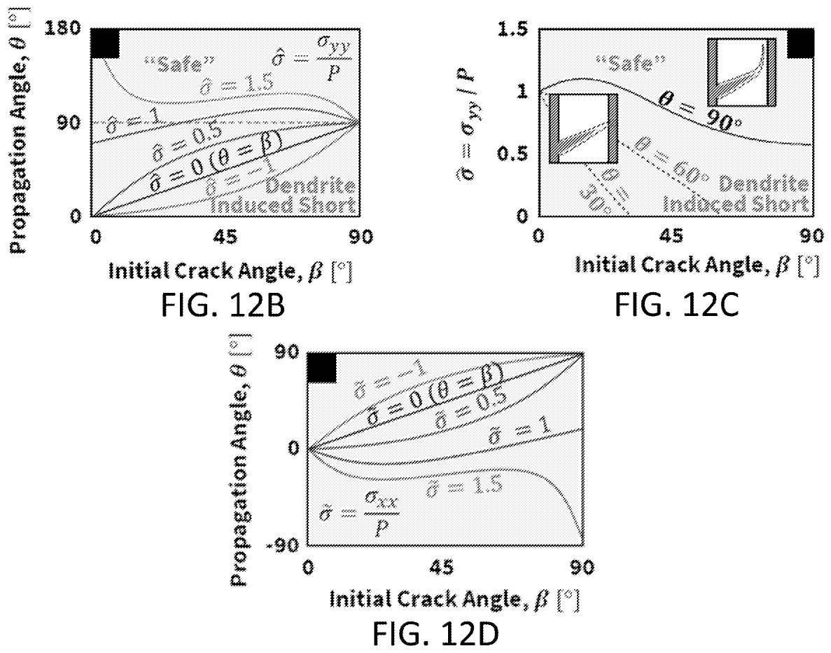

From fracture mechanics, a model was developed to describe the trajectory of the dendrite 191 under mechanical loading. This model was used to interpret the experimental results in Section 2.1 and to define criteria for deflecting dendrites 191 (e.g., to avert electrical shorting). In this model, dendrites 191 are modeled as slit-like metal-filled flaws initially oriented at an angle β from a horizontal axis, as shown in FIG. 12A. It is assumed the solid electrolyte is homogeneous and isotropic. The planar electrolyte/electrode interface is also assumed to be held with fixed x-displacement. Metal plating into the flaw leads to a uniform pressure, P, normal to the face of the flaw. In the absence of any other stresses in the electrolyte, this plating-induced pressure P causes the dendrite to propagate forward without kinking (i.e., without changing direction). An additional load (σₓₓ and/or σ_{yy}) may also be applied due to external forces or from residual stresses present in the solid electrolyte. When the additional load is applied to the solid electrolyte in the vertical direction (σ_{yy}), however, the energetically preferred path for dendrite propagation changes from its initial orientation from the angle β to the angle θ, as seen in FIG. 12A. Note the angle θ is also measured from the horizontal axis.

The energetically preferred path for dendrite propagation may be understood as follows. Crack propagation releases potential energy (stored via elastic strain). Thus, cracks typically propagate in a direction that releases the highest amount of energy. In a slit-like metal-filled flaw (e.g., a crack), the preferred direction for the flaw to propagate is orthogonal to the direction of the pressure, P, applied to the face of the flaw since that is the direction the flaw is most likely to open when the energy release rate exceeds the fracture resistance (e.g., due to the creation of new surfaces, etc.). In FIG. 12A, this direction initially corresponds to the angle β. If a compressive stress is applied along the y-axis to counteract the y-component of the internal pressure, then the only component of the internal pressure that remains is the x-component. Thus, the direction that releases the highest amount of energy changes to the y-direction (i.e., away from the cathode), since that is the direction the flaw is mostly likely to open given the remaining forces acting on the face of the flaw. In this manner, compression perpendicular to the crack acts to decrease the driving force for propagation.

The stress state in front of the crack tip crack is then a result of the superposition of the plating-induced pressure and the applied load. The most favorable propagation angle (θ in FIG. 12A) may correspond to when the local stress intensity factor is at its highest for an infinitesimal extension of the crack tip. The derivation underlying this model is detailed below in Section 2.7. Further, the loading conditions considered in this model are representative of the following two cases: 1) The kinking of propagating metal dendrites upon the application of applied load for a plan-view cell (see left side of FIG. 12A), and 2) the kinking of a metal-filled flaw at the anode/electrolyte interface at the instant propagation begins (see right side of FIG. 12A).

This model provides a way to assess whether the experimental observations are consistent with fracture-governed dendrite propagation. If filament propagation is driven purely by mechanical fracture, the plating-induced pressure P inferred from the experiments would match the fracture stress expected from an ex-situ test (called σ_{critical}). If, on the other hand, propagation is governed largely by chemical degradation, e.g., in the case of failure via electronic leakage, then the inferred P would be appreciably lower than σ_{critical}. The fracture stress, σ_{critical}, is estimated by evaluating the propagation of through-cracks in a thin plate of the geometry in FIG. 7. Applying this analysis to the 90 μm thick LLZTO disc studied (detailed further in Section 2.7) yields σ_{critical} values between 65 and 120 MPa (for LLZTO fracture toughness, K_{IC}, of 1-2 MPa\sqrt{m}). The plating-induced pressure P is independently inferred from the change in filament propagation angle under a known load. From FIG. 7, the measured angles of β=360 and θ=710 under an applied load of 70 MPa yield P=115 MPa, which is similar in magnitude to σ_{critical}. This comparison suggests dendrite propagation is a fracture process in which the plating-induced pressure P is approximately the critical stress for fracture.

The model results capture the experimental observations and provide design criteria for averting failure. The results in FIGS. 12B-12D show that in-plane stresses slightly larger than P may deflect dendrites of any initial orientation, β, to a final angle θ=90°, thereby averting cell shorting. FIG. 12B shows the most energetically favorable propagation angle as a function of the load (given as σ_{yy}/P) and the initial crack inclination, β. For a given β, compressive σ_{yy} increases the propagation angle θ for all β (consistent with FIG. 7), whereas tensile σ_{yy} decreases β. A critical stress exists to reach the design objective of θ=90°. For some range of Θ<90°, short-circuiting may still be avoided depending on the thickness and lateral dimensions of the solid electrolyte. However, for compressive stress, θ is always larger than β until β reaches 90°. Note that a relatively small overstress provides a substantial margin of safety. FIG. 12C shows that a compressive stress only 10% larger than P (i.e., σ_{yy}≈1.1P) results in θ=900 for all initial angles β. This result is consistent with the experimental observation that a 200 MPa load repeatedly deflects all observed filaments to 0≈90° (see FIGS. 10 and 11). In the following section, the critical stress is modeled and corresponding criteria for dendrite deflection in solid-state battery architectures is presented.

### 2.3 Engineering Solid-State Batteries for Dendrite Deflection

The insights described above may be applied to solid-state battery architectures commonly used in commercial products. Generally, the in-plane stresses used to deflect dendrites are not limited only to an externally applied mechanical stress. Rather, the in-plane stresses may be produced in several ways.

For example, the desired in-plane stresses may be achieved using residual thermal stresses arising from a thermal expansion mismatch between two or more layers of a solid-state electrochemical cell. In one illustrative example, a solid-state lithium (Li) cell may include a solid electrolyte layer bound to a lithium metal negative electrode and an oxide cathode (see, for example, the cell 100a in FIG. 1A). Assuming there is no delamination at the Li—solid electrolyte and solid electrolyte—cathode interfaces, a thermal expansion mismatch between the respective layers results in a residual thermal stress. The low yield stress of Li metal (˜1 MPa) suggests the metal is unlikely to maintain a residual thermal stress. Rather, the Li metal is likely to flow to relieve any residual thermal stress. However, a non-ductile solid electrolyte and a non-ductile cathode may be used to generate and sustain a thermal residual stress due to thermal expansion mismatch between these components. To achieve high energy density and fast charging, it is further desirable that the electrolyte be thin relative to the cathode. Under these conditions, the residual stress is primarily borne by the solid electrolyte, as desired. If the cathode has a higher coefficient of thermal expansion than the electrolyte, the electrolyte experiences a residual compressive stress after cooling from a stress-free state at an elevated temperature.

In another example, the desired compressive biaxial stress may be generated in a solid-electrolyte layer by laminating together two solid-electrolytes with different thermal expansion coefficients (see, for example, the cell 100c in FIG. 4A). In this example, the electrolyte with a lower σ receives the compressive stress.

In both examples, the residual compressive stress may be expressed as,

$$σ = {E}^{′} {ε}_{th} = {E}^{′} Δ α Δ T \qquad ( 1 )$$

where σ is the in-plane stress (e.g., σ_{yy} from the right side of FIG. 12A) at the cathode-electrolyte interface, E′ is the electrolyte biaxial elastic modulus, εₜₕ is the strain induced by the cathode and solid electrolyte thermal expansion mismatch, and da is the difference in thermal expansion coefficients of the two layers of materials (e.g., the cathode 112 and the solid electrolyte 114 in the cell 100a, the solid electrolytes 116a and 116b in the cell 100c, materials A and B in FIG. 13B). If there is no mechanical relaxation (e.g., bending, creep, or interfacial delamination), then the resulting residual compression acts to deflect dendrites in the same manner as, P, in FIG. 12A. From the analysis in Section 2.2, P may be taken as σ_{crit}. (

$$\approx \frac{{K}_{IC}}{1.12 \sqrt{π a}}$$

for this loading condition, with K_{IC} and a as 1 MPa\sqrt{m} and 10 μm).

FIG. 13A provides a list of biaxial moduli and thermal expansion coefficient values for several lithium-ion cathodes and electrolytes. As shown, LiFePO₄ (LFP) has a higher a than the three widely-studied solid electrolytes listed (LLZTO, Li₁₀GeP₂Si₂ (LGPS) and Li₁₊ₓAlₓTi₂₋ₓ(PO₄)₃(LATP)). The materials in FIG. 13A are representative of a broader class of solid electrolytes or electrodes, as follows: LLZTO is representative of oxide electrolytes, Li₁₀GeP₂Si₂ (LGPS) is representative of crystalline sulfide electrolytes, Li₁₊ₓAlₓTi₂₋ₓ(PO₄)₃ (LATP) is representative of LISICON electrolytes, and Nickel Manganese Cobalt Oxide (NMC) or Lithium Iron Phosphate (LFP) are representative of various classes of cathodes.

FIG. 13B shows lines of thermal residual stress as a function of processing temperature (assuming a quench to T₁=20° C.) for several solid electrolyte—cathode and solid electrolyte—solid electrolyte pairs. The horizontal dashed line denotes a compressive stress of 150 MPa for complete dendrite deflection. This value is for representative material properties and flaw sizes evaluated in this demonstration and is obtained based on the observation in FIGS. 12A-12D that compressive stresses on the order of P and larger should deflect metal dendrites, mitigating short circuiting (i.e., P≈150 MPa).

The processing temperature values are upper bounds since they are calculated assuming fully dense solids and no plastic deformation under stress. Nonetheless, a modest quench may reach the desired critical residual compressive stress of 150 MPa, e.g., only 50° C. to 60° C. for LATP and LLZO vs LFP, and ˜60° C. for LATP and LLZO vs LGPS. Thermal cycles of this magnitude may be readily incorporated into electrolyte fabrication techniques used to produce dense electrolytes, which often reach temperatures of 100-300° C. On the other hand, for some materials combinations, a much larger temperature excursion is necessary, and may be difficult to achieve. FIG. 13B shows that the critical stress is reached for a quench of 350° C. for LiPON against LLZO, 550° C. for LGPS against LFP, and 1220° C. for LATP against NMC. The results shown may be readily modified for alternative cell architectures and other materials, including composite electrolytes (e.g., co-sintered cathodes/electrolytes as shown in the cell 100d of FIG. 4B). The model also predicts that three parameters, E′, Δα, and ΔT are sufficient to determine the parameters to reach the critical residual compressive stress to achieve complete dendrite deflection (e.g., 150 MPa).

### 2.4 Deleterious Effects of Stack Pressure on Dendrite Propagation

In conventional electrochemical cells, a stack pressure (e.g., σₓₓ in FIG. 12A) is often applied to increase critical current densities and improve the uniformity of metal deposition. Stack pressures typically vary from a few MPa (e.g., about 5 MPa) to several hundred MPa (e.g., about 500 MPa). According to the fracture mechanics model (see Section 2.2), a stack pressure is predicted to have a deleterious effect on battery life by directing dendrite growth towards the electrode, thus resulting in a short circuit. FIG. 12D shows that as the stack pressure increases up to several times the internal pressure, P, the propagation angle θ decreases. This means, the dendrites are more likely to propagate along a direct path to penetrate the electrolyte rather than follow a tortuous path.

### 2.5 Cell Preparation and Assembly

For the example solid-state cells 100f discussed in Section 2.1, polycrystalline LLZTO was obtained from Toshima Manufacturing Inc. (Saitama, Japan) as 1 mm thick, 12.7 mm diameter pellets. The phase purity of these pellets was confirmed via X-ray diffraction, and the bulk conductivity was measured as 1.03 mS/cm in previous studies. LLZTO electrolytes were then mechanically polished to a specified end thickness, using an oil-based 1 μm diamond suspension for the last polishing step. Immediately after polish, the electrolyte discs 114 were transferred into an oven within an argon (Ar) containing glovebox. The discs 114 were heat treated at 500° C. for 3 hours.

The Li metal/LLZTO interface was formed using similar methods to previous studies. Specifically, after heat treatment, the electrolyte discs 114 were removed from the oven. Li metal foil (Alfa Aesar, Ward Hill, Massachusetts, USA) was scraped with a steel spatula to produce a clean metal surface. This Li was then cut into 3 mm diameter pads using a biopsy punch. The Li metal pads 190a and 190b were immediately adhered to the LLZTO disk, and the resulting assembly was placed into the oven and baked at 250° C. for 1 hour.

The resulting plan-view cells 114 were fixed to a cantilever beam 310 using Loctite 401 adhesive. For the experiment shown in FIG. 10, a ⅛″ thick, 1″ wide, 2′ long 6061 aluminum bar (McMaster, Elmhurst, Illinois, United States) was used. All other experiments used ½″ thick, 1″ wide, 2′ long acrylic bars (McMaster, Elmhurst, Illinois, United States). A strain gauge (e.g., the strain gauges 330a and 303b) was fixed to the cantilever beam 310 in the same manner as the cell 100f. The adhesive was allowed to cure for 3 hours. Following this step, the beam 310 was fixed to a rigid frame, as shown in FIG. 1A. The cell 100f and strain gauge were located approximately 18″ from the free end of the beam 310. Tungsten probe tips were inserted into the Li metal electrodes 190a and 190b to provide an electrical connection to a VMP-3 Potentiostat (Biologic, Knoxville, Tennessee, USA). This electrical connection permitted controlled electrochemical cycling within the glovebox.

### 2.6 Operando Measurements

Operando optical measurements were recorded using a Leica DMS300 microscope (e.g., the microscope 320), with the sample backlit using an LED plate. Electrochemical cycling and measurement were conducted using a VMP-3 Potentiostat (Biologic, Knoxville, Tennessee, USA). The currents discussed in Sections 2.1-2.4 were applied to the cell galvanostatically, with the current density representing the applied current divided by the initial Li electrode area.

Meanwhile, strain measurements were collected from the strain gauge, e.g., the strain gauges 330a and/or 330b, (CEA-06-250UN-350/P2, Micro-Measurements, Raleigh, North Carolina, USA) fixed adjacent to the cell 100f. Strain data (Egauge) was collected in real time using a D4 Data acquisition system (Micro-Measurements, Raleigh, North Carolina, USA). The distance from the end of the beam 310 for both the sample, e.g., the cell 100f, (L_{elyte}) and the strain gauge (L_{gauge}) were measured using a ruler. Because the gauge and the sample were positioned at different distances from the end of the bar, they possessed slightly different strains. Thus, the strain in the electrolyte 114 may be estimated by correcting the strain in the strain gauge using beam bending theory. From Euler-Bernoulli beam bending theory, the axial strain at a point on the surface of the cantilever beam 310 may be written as,

$$ε = \frac{6 WL}{{E}_{cantilever} {bh}^{3}} \qquad ( 2 )$$

where W is the weight applied to the free end of the cantilever beam 310, L is the distance from the end of the cantilever beam 310, b is the length of the base of the cantilever beam 310, and h is the height of the cantilever beam 310. From the above equation, the value of ε/L is constant everywhere on the beam 310 assuming a constant load. In testing, holding a test cantilever beam 310 and gauge loaded for a period of several hours did not yield a significant change in the measured strain. Therefore, it may be concluded that the gauge and the sample were rigidly fixed to the cantilever beam 310. Thus, the average strain in the electrolyte 114 (ε_{elyte}) is related to the measured strain in the gauge by,

$$\frac{{ε}_{elyte}}{{L}_{elyte}} = \frac{{ε}_{gauge}}{{L}_{gauge}} \to {ε}_{elyte} = {ε}_{gauge} ( \frac{{L}_{elyte}}{{L}_{gauge}} ) \qquad ( 3 )$$

The electrolyte strain along the cantilever beam's axis was calculated from the measured strain based upon the above equation. Given that the radius r_{elyte} of the electrolyte 114 (0.25″) is very small compared to the distance from the end of the beam 310 (˜18″), the strain state did not appreciably differ at the edges of the electrolyte 114 when compared to the center of the electrolyte 114,

$$( {ε}_{elyte} = \frac{{L}_{elyte} \pm {r}_{elyte}}{{L}_{elyte}} = ( 1 \pm 0.014 ) {ε}_{elyte} ) \qquad ( 4 )$$

Because the electrolyte 114 is very thin compared to the cantilever beam 310, the cantilever beam 310 effectively prevents the electrolyte 114 from straining perpendicular to the beam's axis. Thus, other strains within the plane of the beam's surface may be neglected, yielding a plane strain elastic problem. From Hooke's law, the stress along the beam's axis (σ_{applied}) may be expressed as,

$${σ}_{applied} = \frac{{E}_{LLZTO}}{1 - {v}^{2}} {ε}_{elyte} \qquad ( 5 )$$

The measured stresses reported in Sections 2.1-2.4 are reported as σ_{applied} while taking E_{LLZTO} and v_{LLZTO} as 150 GPa and 0.25, respectively.

Predicting the Kink Angle from Mixed Mode Fracture Mechanics

The maximum strain energy release rate for a crack at angle 90°-β from the direction of a normal load occurs at the kink angle α, which maximizes the local mode I stress intensity factor k, is defined as,

$${k}_{I} ( α ) = {C}_{11} {K}_{I} + {C}_{12} {K}_{II} \qquad ( 6 )$$

where K_{I} and K_{II} are the stress intensity factors for mode I and mode II such that,

$${K}_{I} = {K}_{I ( 0 )} {cos}^{2} β \qquad ( 7 )$$

$${K}_{II} = {K}_{I ( 0 )} cos β sin β \qquad ( 8 )$$

where K_{I(0)} represents the stress intensity factor if the crack was at β=0. Taking the prefactor and crack length as unity yields,

$${K}_{I ( 0 )} = σ \qquad ( 9 )$$

where σ is the applied load, and C₁₁, C₁₂ are coefficients such that,

$${C}_{11} ( α ) = \frac{3}{4} cos ( \frac{α}{2} ) + \frac{1}{4} cos ( \frac{3 α}{2} ) \qquad ( 10 )$$

$${C}_{12} ( α ) = - \frac{3}{4} [ sin ( \frac{α}{2} ) + sin ( \frac{3 α}{2} ) ] \qquad ( 11 )$$

where σ is the angle of the kink from the plane of the crack.

In the problem of interest, there are two applied stresses, which may be superimposed to predict the kink angle for a growing crack: 1) A plating-induced mode I load P of unit pressure and 2) an applied normal (compressive) load of

$$\hat{σ} = \frac{{σ}_{applied}}{P}$$

aligned with the beam's axis, acting upon a crack oriented at angle 90°-β. This second load represents the external compression on the electrolyte 114. The plating-induced pressure is applied normal to the crack faces, and oriented at an angle of β relative to the coordinate system of load 2. Thus, the remotely applied stress state may be described using superposition as,

$$R ( β ) [ \begin{matrix}0 & 0 \\ 0 & 1\end{matrix} ] {R}^{T} ( β ) + [ \begin{matrix}- v \hat{σ} & 0 \\ 0 & - \hat{σ}\end{matrix} ] [ \begin{matrix}{σ}_{xx} & {σ}_{xy} \\ {σ}_{xy} & {σ}_{yy}\end{matrix} ] \qquad ( 12 )$$

where R is the rotation matrix,

$$R ( θ ) = [ \begin{matrix}cos θ & - sin θ \\ sin θ & cos θ\end{matrix} ] \qquad ( 13 )$$

This system may be rotated by an angle θ′ to give the principle stress state, such that,

$$R ( {θ}^{′} + β ) [ \begin{matrix}0 & 0 \\ 0 & 1\end{matrix} ] {R}^{T} ( {θ}^{′} + β ) + R ( {θ}^{′} ) [ \begin{matrix}- v \hat{σ} & 0 \\ 0 & - \hat{σ}\end{matrix} ] R ( {θ}^{′} ) = [ \begin{matrix}{σ}_{1} & 0 \\ 0 & {σ}_{2}\end{matrix} ] \qquad ( 14 )$$

where σ₁ and σ₂ are the principal stresses, with σ₁>σ₂. The exact values of σ₁, σ₂, and θ are determined by the eigenvalues and eigenvectors of the initial system for a given value of \hat{σ} and β. This allows for the determination of the local stress intensity factor by superimposing two principal stresses at 90° to one another, permitting Eqs., 6, 8, and 9, to be rewritten as,

$${K}_{I} = [ {σ}_{1} {cos}^{2} ( β - {θ}^{′} ) + {σ}_{2} {sin}^{2} ( β - {θ}^{′} ) ] \qquad ( 15 )$$

$${K}_{II} = [ ( {σ}_{1} - {σ}_{2} ) sin ( {β}^{′} ) cos ( β - {θ}^{′} ) ] \qquad ( 16 )$$

The most energetically favorable kink angle, α*, is then defined as the angle α that maximizes the local stress intensity factor, k_{I}, now rewritten from Eqs. 1, 15, and 16 as,

$${k}_{I} ( α ) = {C}_{11} ( α ) [ {σ}_{1} {cos}^{2} ( β - {θ}^{′} ) + {σ}_{2} {sin}^{2} ( β - {θ}^{′} ) ] + {C}_{12} ( α ) [ ( {σ}_{1} - {σ}_{2} ) sin ( β - {θ}^{′} ) cos ( β - {θ}^{′} ) ] \qquad ( 17 )$$

This angle α* is determined numerically. Because this kink angle is relative to the initial crack orientation, the direct sum of the most favorable kink angle α* to the crack angle β yields the ultimate propagation angle θ=α*+β discussed in Sections 2.1-2.4.

It should be appreciated that this analysis considers only the most favorable angle of dendritic propagation, which is directly relevant to the amount of material plated prior to failure. A smaller propagation angle implies that more metal plating occurs before dendrite-induced shorting, while a larger angle implies the opposite. However, this analysis does not directly consider the exact value of the driving force after the crack kinks, nor does it investigate the impact of the electric field on propagation. Furthermore, it is assumed the electrolyte 114 is isotropic and homogeneous. In reality, electrolytes 114 possess microstructural features and defects, which may impact the mechanics and thus morphology of propagating flaws.

In the above analysis, the kink angle possesses no direct dependence on flaw size. For a channel crack in a thin film, the critical pressure for fracture possesses no flaw length dependence, so long as the flaw is substantially longer than the film thickness. This greatly simplifies the analysis of the plan-view cells discussed in Sections 2.1-2.4. For a conventional cell format, an indirect dependence on flaw size occurs via the dependence of P on the flaw size. In applying this analysis to conventional cells, a representative flaw size and stress intensity factor for failure should be assumed to estimate a representative P. As discussed in Sections 2.1-2.4, the following is used: a=10 μm and K, =1 MPa·\sqrt{m}. It should be appreciated that for flaws initially smaller than the representative 10 μm used here, the initial value of P is higher. However, with propagation, the value of P decreases until reaching that of the representative flaw discussed here. Thus, the analysis outlined herein should still apply.

### 2.7 Estimating the Mechanical Pressure to Propagate a Channel Crack in a Thin Film

The mechanical pressure to propagate a channel crack in an LLZTO film on the cantilever substrate is estimated, as shown in a in FIG. 10. The dendrite shown in FIG. 10 is treated as a channel crack propagating through a thin film bonded to a semi-infinite elastic substrate. Both the film and the substrate are treated as isotropic, homogeneous, linear elastic materials with known Young's modulus, E, and Poisson ratio, v. Treating this cracking as a plane strain problem, the material dependence depends on the two dimensionless parameters α_{d} and β_{d} (referred to as the Dundurs parameters), such that,

$${α}_{d} = \frac{{\overline{E}}_{film} - {\overline{E}}_{sub .}}{{\overline{E}}_{film} + {\overline{E}}_{sub}} \qquad ( 18 )$$

$${β}_{d} = \frac{{μ}_{film} ( 1 - 2 {v}_{sub .} ) - {μ}_{sub .} ( 1 - 2 {v}_{film} )}{2 {μ}_{film} ( 1 - {v}_{sub .} ) + 2 {μ}_{sub .} ( 1 - {v}_{film} )} \qquad ( 19 )$$

where Ē is the plane strain modulus, Ē=E/(1−v²), and y is the shear modulus, μ=2E/(1+v). The only two length scales present in this problem are the film thickness and the crack length. According to previous studies, in the limit that the crack length is larger than the film thickness, the strain energy release rate (and thus stress intensity factor) is independent of crack length. Thus, the steady state energy release rate (Gₛₛ) for a uniform stress a on the crack face may be estimated as follows,

$${G}_{ss .} = g ( {α}_{d} , {β}_{d} ) \frac{π}{2} \frac{{σ}^{2} {t}_{film}}{{\overline{E}}_{film}} \qquad ( 20 )$$

where g is a function of the Dundurs parameters, and t_{film} is the film thickness. For crack propagation, this strain energy release rate is equal to the critical strain energy release rate for fracture (F), which may be related to measured K_{1C} values as follows,

$$Γ = \frac{{K}_{1 C}^{2}}{{\overline{E}}_{film}} = g ( {α}_{d} , {β}_{d} ) \frac{π}{2} \frac{{σ}_{crit .}^{2} {t}_{film}}{{\overline{E}}_{film}} \qquad ( 21 )$$

Thus, solving for the critical stress σ_{crit.} yields,

$${σ}_{crit .} = \sqrt{\frac{1}{g ( {α}_{d} , {β}_{d} )} \frac{2}{π} \frac{{K}_{1 C}^{2}}{{r}_{film}}} \qquad ( 22 )$$

In modelling the LLZTO film, it is assumed E_{film}=150 GPa and v=0.25. Meanwhile, the elastic properties of the cantilever beam 310 (6061 Aluminum for FIG. 10) are assumed to be E_{sub.}=70 GPa and v=0.25. These material properties yield Dundurs parameters of α_{d}=0.36 and β_{d}=0.04, where g(α_{d}=0.36, β_{d}=0.04)=1.74. The LLZTO film shown in FIG. 10 was measured as 90 μm using an optical microscope (BA 310 met, Motic, Barcelona, Spain) with 50× objective. The actual K_{1C} (based upon indentation fracture toughness measurements) appears to vary between 1-2 MPa\sqrt{m}, as would be expected for a brittle ceramic. Taking 1 and 2 MPa\sqrt{m} as upper and lower bounds produce σ_{crit.} between 65 and 120 MPa\sqrt{m}.

### 3. CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A solid-state electrochemical cell, comprising:
an anode comprising lithium (Li);
a cathode; and
a solid electrolyte disposed between and directly coupled to the anode and the cathode, at least a portion of the solid electrolyte is under compressive stress,
wherein:
while charging or discharging the cell, an electric field is generated in the solid electrolyte between the anode and the cathode;
the compressive stress includes at least one stress component oriented along a first direction that is substantially orthogonal to a direction of the electric field in the portion of the solid electrolyte; and
the at least one stress component is configured to deflect a Li dendrite, originating from the anode and located in the portion of the solid electrolyte, away from the cathode.

2. The cell of claim 1, wherein an angle between the first direction of the at least one stress component and the direction of the electric field ranges from about 85 degrees to about 95 degrees.

3. The cell of claim 1, wherein the at least one stress component has a magnitude ranging from about 50 MPa to about 1000 MPa.

4. The cell of claim 1, wherein the at least one stress component is configured to deflect the Li dendrite by causing a change in a propagation angle of the Li dendrite, the change in the propagation angle ranging from about 10 degrees to about 90 degrees.

5. The cell of claim 1, wherein the at least one stress component is configured to deflect the Li dendrite towards the first direction such that an angle between the first direction and a propagation direction of the Li dendrite is less than or equal to about 10 degrees.

6. The cell of claim 1, wherein:
the solid electrolyte has a width parallel to the first direction; and
the portion of the solid electrolyte under compressive stress extends across the width of the solid electrolyte.

7. The cell of claim 1, wherein the compressive stress is a uniaxial compressive stress oriented along the first direction.

8. The cell of claim 1, wherein the compressive stress is a biaxial compressive stress oriented along the first direction and a second direction orthogonal to the first direction and the direction of the electric field in the portion of the solid electrolyte.

9. The cell of claim 1, further comprising:
a casing to enclose the anode, the cathode, and the solid electrolyte,
wherein the casing applies a mechanical load to at least one of the anode, the cathode, or the solid electrolyte thereby causing the portion of the solid electrolyte to be under compressive stress.

10. The cell of claim 9, wherein the casing comprises a clamp to securely couple the anode, the cathode, and the solid electrolyte to the casing, the clamp applying the mechanical load to the at least one of the anode, the cathode, or the solid electrolyte.

11. The cell of claim 9, wherein:
the casing includes a surface; and
one of the anode or the cathode is bonded to the surface such that a residual stress is generated at the one of the anode or the cathode, the residual stress causing the mechanical load to be applied to the at least one of the anode, the cathode, or the solid electrolyte.

12. The cell of claim 9, wherein:
the mechanical load bends the anode, the cathode, and the solid electrolyte thereby generating a bending stress in the anode, the cathode, and the solid electrolyte; and
the bending stress causes at least the portion of the solid electrolyte to be under compressive stress.

13. The cell of claim 9, wherein the casing does not apply a stack pressure to the anode, the cathode, and the solid electrolyte.

14. The cell of claim 1, wherein the compressive stress is caused by a thermal expansion mismatch between the cathode and the solid electrolyte.

15. The cell of claim 14, wherein:
the solid electrolyte has a first thickness less than a second thickness of the cathode; and
the solid electrolyte has a first coefficient of thermal expansion less than a second coefficient of thermal expansion of the cathode.

16. The cell of claim 14, wherein:
the solid electrolyte comprises at least one of an oxide electrolyte, a crystalline sulfide electrolyte, or a lithium super ionic conductor (LISICON) electrolyte; and
the cathode comprises at least one of a nickel manganese cobalt oxide, or a lithium iron phosphate.

17. The cell of claim 1, wherein:
the solid electrolyte comprises:
a first layer of a first solid electrolyte, the first layer including the portion of the solid electrolyte under compressive stress; and
a second layer, coupled to the first layer, of a second solid electrolyte different from the first solid electrolyte; and
the compressive stress is caused by a thermal expansion mismatch between the first layer and the second layer.

18. The cell of claim 1, wherein the compressive stress is caused by at least one of an electrochemical reaction or a chemical reaction at the portion of the solid electrolyte.

19. A solid-state electrochemical cell, comprising:
an anode comprising lithium (Li);
a cathode;
a solid electrolyte disposed between and directly coupled to the anode and the cathode, at least a portion of the solid electrolyte is under compressive stress, the compressive stress being caused by a thermal expansion mismatch between the cathode and the solid electrolyte; and
a casing to enclose the anode, the cathode, and the solid electrolyte,
wherein:
while charging or discharging the cell, an electric field is generated in the solid electrolyte between the anode and the cathode;
the compressive stress includes at least one stress component oriented along a first direction that is substantially orthogonal to a direction of the electric field in the portion of the solid electrolyte; and
the casing does not apply a stack pressure to the anode, the cathode, and the solid electrolyte.

20. A method of making a solid-state electrochemical cell, the method comprising:
joining together an anode, a solid electrolyte, and a cathode at a first temperature such that the solid electrolyte is disposed between and directly coupled to the anode and the cathode;
cooling the anode, the solid electrolyte, and the cathode from the first temperature to a second temperature less than the first temperature at a cooling rate sufficient to generate a residual thermal stress in at least the solid electrolyte, the residual thermal stress causing at least a portion of the solid electrolyte to be under compressive stress so as to deflect a Li dendrite in the portion of the solid electrolyte during operation of the cell;
joining the anode to a first electrode;
joining the cathode to a second electrode; and
mounting the anode, the solid electrolyte, and the cathode to a casing such that the casing does not cause a stack pressure to at least the solid electrolyte with a magnitude greater than 10 MPa,
wherein:
during operation of the cell, an electric field is generated in the solid electrolyte between the anode and the cathode; and
the compressive stress includes at least one stress component oriented along a first direction that is substantially orthogonal to a direction of the electric field in the portion of the solid electrolyte.
